(19) United States
(12) Patent Application Publication
(10) Pub. No.: US 2024/0427813 A1
(43) Pub. Date: Dec. 26, 2024

(54) COMPUTER IMPLEMENTED METHOD FOR PRODUCING A PATENT-DATA BASED INDICATOR

(71) Applicant: ECONSIGHT AG, Basel (CH)

(72) Inventors: Jochen SPUCK, Basel (CH); Michael FREUNEK, Basel (CH); Kai GRAMKE, Basel (CH)

(73) Assignee: ECONSIGHT AG, Basel (CH)

(21) Appl. No.: 18/707,456

(22) PCT Filed: Nov. 4, 2022
(86) PCT No.: PCT/EP2022/080838

§ 371 Date: May 3, 2024

(30) Foreign Application Priority Data
Nov. 5, 2021 (EP) 21206773.0
Jun. 24, 2022 (EP) 22181120.1

(51) Int. Cl. G06F 16/35; G06F 16/33

(52) U.S. Cl. CPC G06F 16/353; G06F 16/3347

(57) ABSTRACT

One aspect is a computer-implemented method for producing an indicator. The method includes:
a. obtaining at least one quality index model of the first kind;
b. providing at least one IP product;
c. labelling the at least one IP product, using the at least one quality index model of the first kind, with at least one quality index of the first kind;
d. obtaining the indicator using the at least one quality index of the first kind;

wherein the at least one IP product is labelled with the quality index of the first kind independently of at least one other IP product.

### FIELD OF THE INVENTION

The invention pertains to a computer-implemented method for producing an indicator, wherein the method comprises the steps of
a. obtaining at least one quality index model of the first kind;
b. providing at least one IP product;
c. labelling the at least one IP product, using the at least one quality index model of the first kind, with at least one quality index of the first kind;
d. obtaining the indicator using the at least one quality index of the first kind;

wherein
the at least one IP product is labelled with the quality index of the first kind independently of at least one other IP product.

The invention also pertains to an indicator, obtainable by a computer implemented method according to the invention.

### BACKGROUND

The development of new technical activities or new technical products by entities (e.g., companies or individuals) very often involves a step of searching electronic databases that contain technical documents (e.g., patents and patent applications). If the electronic database is stored remotely (e.g., on a database server), this means that the entity has to be continually connected to a reliable, high-speed computer network in order to perform the search. Being connected to the computer network, in turn, very often also exposes the entity to security risks. If the electronic database is stored locally (e.g., on each of the computing devices of the employees working for the entity) this requires significant amounts of hard disk space. This also makes it increasingly difficult to electronically transfer information between entities. The above problems are not only faced by an entity during the development of new technical activities or new technical products, but very often also during training of the entity.

In addition to the above, regardless of whether the electronic database is stored remotely or locally, the search is often performed over electronic databases that contain millions of data entries. Such a search generally requires large amounts of computer resources, such as random access memory (RAM) and processing power. Furthermore, the search results very often have to be processed, which also required large amounts of computer resources.

### Objects

An object of the present invention is to at least partially overcome at least one of the disadvantages encountered in the state of the art.

It is a further object of the invention to provide a method for producing an indicator that requires less network resources, e.g., bandwidth of a network connection, for searching an electronic database.

It is a further object of the invention to provide a method for producing an indicator that has an increased network security.

It is a further object of the invention to provide a method for producing an indicator that requires less computational resources, e.g., primary storage (such as hard disk space), secondary storage (such as RAM), and processing power, for searching an electronic database.

It is a further object of the invention to provide a method for producing an indicator that requires less computational resources for evaluating search results obtained from searching a database.

It is a further object of the invention to provide a method for producing an indicator that requires less visualisation resources, e.g., the number of computer screens, the size of a computer screen, paper.

### PREFERRED EMBODIMENTS OF THE INVENTION

A contribution to at least partially fulfilling at least one of the above-mentioned objects is made by any of the embodiments of the invention.

A 1^{st} embodiment of the invention is a computer-implemented method for producing an indicator, wherein the method comprises the steps of
a. obtaining at least one quality index model of the first kind;
b. providing at least one IP product;
c. labelling the at least one IP product, using the at least one quality index model of the first kind, with at least one quality index of the first kind;
d. obtaining the indicator using the at least one quality index of the first kind;

wherein
the at least one IP product is labelled with the quality index of the first kind independently of at least one other IP product.

In an aspect of the 1^{st} embodiment, the feature “wherein the at least one IP product is labelled with the quality index of the first kind independently of at least one other IP product” should preferably be understood to mean the following: when labelling an IP product with the at least one quality index of the first kind, the at least one quality index model of the first kind does not require that at least two IP products are used as input in the at least one quality index model of the first kind. For example, the at least one quality index of the first kind can label a single IP product even if only the single IP product is used as input in the at least one quality index model of the first kind. An example (preferably not according to the invention) of a quality index model of the first kind that labels an IP product with a quality index of the first kind dependently of at least one other IP product is the following: at least two IP products are used as input in the quality index model of the first kind, and the quality index of the first kind is obtained by comparing the at least two IP products with each other, or ranking the at least two IP products relative to each other. E.g., a quality index of the first kind that indicates whether a first patent (the IP product) is novel with respect to a further patent (the other IP product) requires that the first patent is labelled with the quality index of the first kind dependently of the further patent.

In an aspect of the 1^{st} embodiment, it is preferred that the at least one IP product comprises text data. In an aspect of the 1^{st} embodiment, it is preferred that the at least one quality index model of the first kind labels the at least one IP product with the at least one quality index of the first kind using at least one or all of the following: the textual structure (e.g., a claim structure) of the at least one IP product, the text data of the at least one IP product, or both. E.g., the text data of the at least one IP product is used as input in the quality index model of the first kind, with the quality index of the first kind being the output of the quality index model of the first kind.

In an aspect of the 1^{st} embodiment, at least one or all of the following is preferred: separately obtaining an indicator for each IP product (e.g., a first indicator is obtained for a first IP product and a further indicator is obtained for a further IP product); obtaining an indicator for multiple IP products (e.g., a single indicator is obtained for the first IP product and the further IP product).

In a preferred embodiment of the computer-implemented method, the at least one IP product comprises text data, and the method further comprises the step of vectorising the text data of the at least one IP product. This preferred embodiment is a 2^{nd} embodiment of the invention, that preferably depends on the 1^{st} embodiment of the invention.

In an aspect of the 2^{nd} embodiment, it is preferred that the vectorization is performed prior to step c. in the 1^{st} embodiment, and more preferably after step b. in the 1^{st} embodiment.

In an aspect of the 2^{nd} embodiment, it is preferred that the at least one quality index model of the first kind labels the at least one IP product with the at least one quality index of the first kind using at least one or all of the following: the vectorized textual structure (e.g., a claim structure) of the at least one IP product, the vectorized text data of the at least one IP product, or both. E.g., the vectorized text data of the at least one IP product is used as input in the quality index model of the first kind, with the quality index of the first kind being the output of the quality index model of the first kind.

In a preferred embodiment of the computer-implemented method, the at least one IP product comprises text data, and the at least one IP product is labelled with the quality index of the first kind using the text data of the at least one IP product. This preferred embodiment is a 3rd embodiment of the invention, that preferably depends on any of the 1^{st} to 2^{nd} embodiments of the invention.

In a preferred embodiment of the computer-implemented method, the at least one quality index model of the first kind is obtained using a plurality of IP disclosures of a first kind. This preferred embodiment is a 4th embodiment of the invention, that preferably depends on any of the 1^{st} to 3rd embodiments of the invention. In an aspect of the 4th embodiment, it is preferred that at least one, more preferably 50%, and further preferably all of the IP disclosures of the first kind comprise text data. In this aspect, it is preferred that the at least one quality index model of the first kind is obtained using the text data of at least one, more preferably 50%, and further preferably all of the IP disclosures of the first kind.

In a preferred embodiment of the computer-implemented method, at least one IP disclosure of the first kind comprises text data, and prior to obtaining the quality index model of the first kind, the text data of at least one IP disclosure of the first kind is vectorized. This preferred embodiment is a 5th embodiment of the invention, that preferably depends on any of the 1^{st} to 4^{th} embodiments of the invention.

In an aspect of the 5^{th} embodiment, it is preferred that at least one, more preferably 50%, and further preferably all of the IP disclosures of the first kind comprise text data. In an aspect of the 5^{th} embodiment, it is preferred that the text data of at least one, more preferably 50%, and further preferably all of the IP disclosures of the first kind is vectorized. In an aspect of the 5^{th} embodiment, it is preferred that the at least one quality index model of the first kind is obtained using at least one or all of the following: the vectorized textual structure (e.g., a claim structure) of the at least one IP disclosure of the first kind, the vectorized text data of the at least one IP disclosure of the first kind, or both. E.g., the vectorized text data of the at least one IP disclosure of the first kind is used to train the quality index model of the first kind using machine learning, neural networks, or both.

In a preferred embodiment of the computer-implemented method, the method further comprises the step of providing at least one, preferably at least two, more preferably at least 10, and further preferably at least 20 classifications. This preferred embodiment is a 6^{th} embodiment of the invention, that preferably depends on any of the 1^{st} to 5^{th} embodiments of the invention.

In a preferred embodiment of the computer-implemented method, the method further comprises the step of obtaining at least one classification model. This preferred embodiment is a 7^{th} embodiment of the invention, that preferably depends on any of the 1^{st} to 6^{th} embodiments of the invention. In an aspect of the 7^{th} embodiment, it is preferred that the classification model is obtained before, after, or at least partially simultaneously with performing at least one or all of the steps a. to d. in the 1^{st} embodiment.

In a preferred embodiment of the computer-implemented method, at least one or all of the following is based on the at least one classification:
a. the at least one quality index model of the first kind;
b. the indicator;
c. the classification model.

This preferred embodiment is an 8^{th} embodiment of the invention, that preferably depends on any of the 1^{st} to 7^{th} embodiments of the invention. In an aspect of the 8^{th} embodiment, all possible combination of the features a. to c. are preferred aspects of the embodiment. These combinations are e.g., a; b; c; a, b; a, c; b, c; a, b, c. In an aspect of the 8^{th} embodiment, it is preferred that at least one or all of the features a. to c. are based on at least two, more preferably at least 10, and further preferably at least 20 classifications.

In a preferred embodiment of the computer-implemented method, the at least one classification is based on at least one or all of the following:
a. at least one technical activity;
b. at least one technical product;
c. at least one field of technology;
d. at least one patent classification, e.g., an International Patent Classification (IPC), a Cooperative Patent Classification (CPC), an FI-Class, and an F-Term;
e. at least one standard, e.g., ETSI, FDA, ANSI, DIN, ISO;
f. at least one category, e.g., Web of Science categories, a concordance list, a taxonomy categorization, such as the EU commissions taxonomy for ESG related technologies or the UN Goals of sustainability;
g. at least one technical concept;
h. at least one collection, e.g., a collection of IP products, a collection of IP disclosures;
i. at least one scientific text;
j. a combination of two or more of the above.

This preferred embodiment is a 9^{th} embodiment of the invention, that preferably depends on any of the 6^{th} to 8^{th} embodiments of the invention. In an aspect of the 9^{th} embodiment, all possible combination of the features a. to i. are preferred aspects of the embodiment. In an aspect of the 9^{th} embodiment, all possible combination of the features a. to j. are preferred aspects of the embodiment.

In an aspect of the 9^{th} embodiment, it is preferred that the at least one technical activity is an activity that at least one patent office would consider as an invention. In an aspect of the 9^{th} embodiment, it is preferred that the at least one technical activity is a method, a use, and combinations thereof. Examples of the at least one technical activity is the recycling of polyethylene terephthalate and a computer implemented method, such as a computer implemented method, according to the invention, for producing an indicator. In another aspect of the 9^{th} embodiment, the at least one technical activity is preferably a technical activity of at least one entity, a society, or a combination thereof.

In an aspect of the 9^{th} embodiment, it is preferred that the at least one technical product is a product that at least one patent office would consider as an invention. In a further aspect of the 9^{th} embodiment, it is preferred that the technical product is at least one or all of the following: a device, a composition, a compound, a kit, or a combination of two or more thereof. Examples of technical products are a metal alloy and a hard drive for a computer. In yet a further aspect of the 9^{th} embodiment, the technical product is preferably a technical product of at least one entity, a society, or a combination thereof.

Examples of the at least one field of technology in the 9^{th} embodiment include robotics, autonomous vehicles, and fertiliser production. In another aspect of the 9^{th} embodiment, it is preferred that at least one, preferably at least two, more preferably at least 10 technical activities fall within a field of technology. In yet another aspect of the 9^{th} embodiment, it is preferred that at least one, preferably at least two, more preferably at least 10 technical products fall within a field of technology. E.g., a method used for steering an autonomous vehicle (a technical activity) and a camera (a technical product) both fall within the field of technology of “autonomous vehicles”. Another example of fields of technology are the technology trends that are identified in the Gartner's Hype Cycle (see, for example, https://www.gartner.com/en/research/methodologies/gartner-hype-cycle).

Examples of the at least one technical concept in the 9^{th} embodiment include: a technical concept defined by a Boolean keyword patent search and/or literature search; a technical concept defined by an automated patent search and/or literature search; a technological concept descriptor, such as Derwent Manual, Polymer Codes, Chemical Abstract, Polymer Class Terms; a technical concept defined by a text collection, such as Wikipedia, a technical document collection, a patent collection, and a literature collection. Examples of a scientific text is an article published in an academic journal, such as Nature or Science.

In a preferred embodiment of the computer-implemented method, at least one or all of the following applies:
a. the plurality of IP disclosures of the first kind is classified according to the at least one classification, preferably using a classification model, more preferably using the classification model according to the invention.
b. the at least one IP product is classified according to the at least one classification, preferably using a classification model, more preferably using the classification model according to the invention.

This preferred embodiment is a 10^{th} embodiment of the invention, that preferably depends on any of the 6^{th} to 9^{th} embodiments of the invention. In an aspect of the 10^{th} embodiment, all possible combination of the features a. and b. are preferred aspects of the embodiment. These combinations are e.g., a; b; a, b.

In a preferred embodiment of the computer-implemented method, at least one or all of the following:
A.] the at least one quality index model of the first kind;
B.] the indicator; and
C.] the classification model;

are obtained using at least one or all of the following:
a. machine learning;
b. artificial intelligence.

This preferred embodiment is an 11^{th} embodiment of the invention, that preferably depends on any of the 1^{st} to 10^{th} embodiments of the invention. In an aspect of the 11^{th} embodiment, all possible combination of the features A.] to C.] are preferred aspects of the embodiment. These combinations are e.g., A.]; B.]; C.]; A.], B.]; A.], C.]; B.], C.]; A.], B.], C.]. In a further aspect of the 11^{th} embodiment, all possible combination of the features a. to b. are preferred aspects of the embodiment. These combinations are e.g., a; b; a, b. In yet another aspect of the 11^{th} embodiment, all possible combination of the features A.] to C.] with the features a. to b. are preferred aspects of the embodiment. In an aspect of the 11^{th} embodiment, it is preferred to use machine learning techniques, models or both, adapted and arranged for natural language processing.

In a preferred embodiment of the computer-implemented method, at least one or all of the following:
A.] the at least one quality index model of the first kind;
B.] the indicator; and
C.] the classification model;

are obtained using at least one or all of the following:
a. supervised learning;
b. unsupervised learning;
c. self-supervised learning;
d. semi-supervised learning; and
e. reinforced learning.

This preferred embodiment is a 12^{th} embodiment of the invention, that preferably depends on any of the 1^{st} to 11^{th} embodiments of the invention. In an aspect of the 12^{th} embodiment, all possible combination of the features A.] to C.] are preferred aspects of the embodiment. These combinations are e.g., A.]; B.]; C.]; A.], B.]; A.], C.]; B.], C.]; A.], B.], C.]. In a further aspect of the 12^{th} embodiment, all possible combination of the features a. to e. are preferred aspects of the embodiment. These combinations are e.g., a; b; c; d; e; a, b; a, c; a, d; a, e; b, c; b, d; b, e; c, d; c, e; d, e; a, b, c; a, b, d; a, b, e; a, c, d; a, c, e; a, d, e; b, c, d; b, c, e; b, d, e; c, d, e; a, b, c, d; a, b, c, e; a, b, d, e; a, c, d, e; b, c, d, e; a, b, c, d, e. In yet another aspect of the 12^{th} embodiment, all possible combination of the features A.] to C.] with the features a. to c. are preferred aspects of the embodiment.

In a preferred embodiment of the computer-implemented method, at least one or all of the following:
A.] the at least one quality index model of the first kind;
B.] the indicator; and
C.] the classification model;

are obtained using at least one or all of the following:
a. at least one artificial neural network e.g., a shallow neural network, a deep neural network, a feedforward neural network, a convolutional neural network, a recurrent neural network, e.g., Word2Vec;
b. boosting;
c. at least one decision tree;
d. at least one support vector machine;
e. at least one random forest;
f. k-means;
g. self-attention;
h. Naïve Bayes,
i. k-nearest neighbour;
j. logistic regression;
k. term frequency-inverse document frequency;
l. transformer deep learning model;
m. a combination of two or more of the above.

This preferred embodiment is a 13^{th} embodiment of the invention, that preferably depends on any of the 1^{st} to 12^{th} embodiments of the invention. In an aspect of the 13^{th} embodiment, all possible combination of the features A.] to C.] are preferred aspects of the embodiment. These combinations are e.g., A.]; B.]; C.]; A.], B.]; A.], C.]; B.], C.]; A.], B.], C.]. In a further aspect of the 13^{th} embodiment, all combinations of the features a. to m. are preferred aspect of the embodiment. In yet another aspect of the 13^{th} embodiment, all possible combination of the features A.] to C.] with the features a. to m. are preferred aspects of the embodiment. In an aspect of the 13^{th} embodiment, it is preferred that a combination of self-attenuation and at least one artificial neural network is used to obtain at least one or all of the following: the classification model, the at least one quality index model of the first kind, the indicator. An example of such a combination is the Bidirectional Encoder Representations from Transformers technique.

In an aspect of the 13^{th} embodiment, it is preferred to use a neural network to obtain at least one or all of the following: the at least one quality index model of the first kind, the indicator. Examples of a neural network include a Feedforward Neural Network, a Convolutional Neural Network, a Long Short Term Memory Network, a Recurrent Neural Network, a Generative Adversarial Network, a Radial Basis Function Network, a Multilayer Perceptron, a Self-Organizing Map, a Deep Belief Network, a Restricted Boltzmann Machine, and an Autoencoder. In this aspect, it is particularly preferred to use vectorized text data (e.g., vectorized text data of the at least one IP product and/or vectorized text data of the at least one IP disclosure of the first kind) together with a neural network (e.g., a feedforward neural network) to obtain the at least one quality index model of the first kind.

In a preferred embodiment of the computer-implemented method, the quality index of the first kind is at least one or all of the following:
a. a likelihood of an outcome for the at least one IP product;
b. a likelihood that a type of objection will be raised against the at least one IP product during prosecution proceedings;
c. a likelihood that a geographical scope (e.g., the countries or regions where the at least one IP product has been filed in, the countries or regions where the at least one IP product is in force, or a combination thereof) of the at least one IP product will change;
d. a likelihood that the at least one IP product will receive a certain number of citations;
e. an estimate of a lifetime of the at least one IP product (e.g., how long the at least one IP product will remain in force);
f. an estimate of a value of the at least one IP product (e.g., a monetary value);
g. a likelihood of an inter partes activity for the at least one IP product;
h. a combination of two or more of the above.

This preferred embodiment is a 14^{th} embodiment of the invention, that preferably depends on any of the 1^{st} to 13^{th} embodiments of the invention. In an aspect of the 14^{th} embodiment, all possible combination of the features a. to h. are preferred aspects of the embodiment.

Examples of an outcome of the at least one IP product in the 14^{th} embodiment include: a grant, a refusal, an abandonment, a withdrawal, a deemed withdrawal, an opposition, or a combination of two or more thereof. Particularly preferred examples of an outcome of the at least one IP product in the 14^{th} embodiment include: a grant, a refusal, an abandonment, a withdrawal, a deemed withdrawal, or a combination of two or more thereof. In an aspect of the 14^{th} embodiment, it is preferred that the likelihood of an outcome for the at least one IP product is either the likelihood of grant of the at least one IP product, the likelihood that the at least one IP product will be challenged (e.g., in opposition proceedings, nullity proceedings), or both. In this aspect, it is more preferred that the likelihood of an outcome for the at least one IP product is the likelihood of grant of the at least one IP product.

Examples of a type of objection that can be raised against the at least one IP product in the 14^{th} embodiment include: a lack of clarity, a lack of enablement, a lack of unity, a lack of novelty, a lack of inventive step, a lack of industrial applicability, an extension of matter, multi-dependent claims, or a combination of two or more thereof. Examples of prosecution proceedings in the 14^{th} embodiment include: proceedings for the grant of the at least one IP product, nullity proceedings against the at least one IP product, infringement proceedings based the at least one IP product, or a combination of two or more thereof.

A further example of a likelihood that a geographical scope of the at least one IP product will change in the 14^{th} embodiment include the likelihood that the IP product will be filed in a number of countries or regions. E.g., the IP product is a patent application, and the likelihood that the geographical scope of the patent application will change is the likelihood that the patent application will be filed in a certain number of countries and/or that the patent application will be filed in certain countries.

Examples of inter partes activities in the 14^{th} embodiment include: the at least one IP product is opposed in opposition proceedings, the at least one IP product is the subject of a litigation proceedings (e.g., nullity proceedings, patent infringement proceedings), the at least one IP product is licensed to a third party, or a combination of at least two thereof.

In a preferred embodiment of the computer-implemented method, the at least one quality index model of the first kind is obtained using at least one or all of the following:
a. an outcome of at least one IP disclosure of the first kind;
b. a number of citations, preferably forward citations, to at least one IP disclosure of the first kind;
c. a geographical scope of at least one IP disclosure of the first kind (e.g., the countries or regions where at least one IP disclosure of the first kind has been filed in, the countries or regions where at least one IP disclosure of the first kind is in force, or a combination thereof);
d. a likelihood of an outcome for at least one IP disclosure of the first kind;
e. a number of objections raised against at least one IP disclosure of the first kind during prosecution proceedings;
f. a type of objections raised against at least one IP disclosure of the first kind during prosecution proceedings;
g. a lifetime of at least one IP disclosure of the first kind (e.g., the number of months that at least one IP disclosure of the first kind remained in force);
h. a value of at least one IP disclosure of the first kind (e.g., a monetary value);
i. a citation measure of at least one IP disclosure of the first kind;
j. an inter partes activity of the at least one IP disclosure of the first kind;
k. metadata of the at least one IP disclosure of the first kind;
l. a combination of two or more of the above.

This preferred embodiment is a 15^{th} embodiment of the invention, that preferably depends on any of the 1^{st} to 14^{th} embodiments of the invention. In an aspect of the 15^{th} embodiment, all combinations of the features a. to l. are preferred aspects of the invention. In an aspect of the 15^{th} embodiment, it is particularly preferred that the at least one quality index model of the first kind is obtained using at least one or all of the features a. to d. In an aspect of the 15^{th} embodiment, it is preferred that at least one or all of the features a. to l. are used as parameters in a process, such as training a model using machine learning for obtaining the quality index model of the first kind.

Examples of an outcome of at least one IP disclosure of the first kind in the 15^{th} embodiment include: a grant, a refusal, an abandonment, a withdrawal, a deemed withdrawal, an opposition, or a combination of two or more thereof. Particularly preferred examples of an outcome of at least one IP disclosure of the first kind in the 15^{th} embodiment include: a grant, a refusal, an abandonment, a withdrawal, a deemed withdrawal, or a combination of two or more thereof. Examples of a types of objection that can be raised against at least one IP disclosure of the first kind in the 15^{th} embodiment include: a lack of clarity, a lack of enablement, a lack of unity, a lack of novelty, a lack of inventive step, a lack of industrial applicability, an extension of matter, multi-dependent claims, or a combination of two or more thereof. Examples of prosecution proceedings in the 15^{th} embodiment include: proceedings for the grant of at least one IP disclosure of the first kind, nullity proceedings against at least one first IP proceedings, infringement proceedings based on at least one IP disclosure of the first kind, or a combination of two or more thereof. A particularly preferred example of prosecution proceedings in the 15^{th} embodiment is proceedings for the grant of at least one IP disclosure of the first kind

Examples of inter partes activities in the 15^{th} embodiment include: the at least one IP disclosure of the first kind is opposed in opposition proceedings, the at least one IP disclosure of the first kind is the subject of a litigation proceedings (e.g., nullity proceedings, patent infringement proceedings), the at least one IP disclosure of the first kind is licensed to a third party, or a combination of at least two thereof.

Examples of metadata in the 15^{th} embodiment include the following of the at least one IP disclosure of the first kind: the number of independent claims, the number of dependent claims, the number of inventors, the number of patent families, the number of countries where the IP disclosure of the first kind has been filed, the number of assignees, the number of CPC classifications, the number of IPC classifications, the number of words in the abstract, the number of words in the claims, the background of the inventors (e.g., level of education (such as Ph.D.), field of expertise, age), type of applicant (e.g., university, number of employees of applicant), and a combination of two or more thereof.

In a preferred embodiment of the computer-implemented method, the method further comprises the steps of
a. providing at least one classification;
b. obtaining a first plurality of IP disclosures of the first kind, wherein at least 80%, preferably at least 95% of said IP disclosures of the first kind have been classified with the at least one classification;
c. obtaining a number of inter partes activities of the first plurality of IP disclosures of the first kind.

This preferred embodiment is a 16^{th} embodiment of the invention, that preferably depends on any of the 1^{st} to 15^{th} embodiments of the invention. In a preferred aspect of the 16^{th} embodiment, it is preferred that the steps a. to c. in the 16^{th} embodiment is performed prior to step a. in the 1^{st} embodiment.

Examples of the at least one classification in the 16^{th} embodiment are given in the 9^{th} embodiment of the invention, and in the preferred aspects of the 9^{th} embodiment. In an aspect of the 16^{th} embodiment, it is preferred that the first plurality of IP disclosures of the first kind have been classified using a classification model, more preferably using the classification model according to the invention. In an aspect of the 16^{th} embodiment, it is preferred that the at least one IP product is classified with the same classification(s) as the first plurality of IP products of the first kind.

In an aspect of the 16^{th} embodiment, it is preferred that the at least one quality index model of the first kind is obtained (step a. in the 1^{st} embodiment) using the number of inter partes activities, the first plurality of IP disclosures of the first kind, or both. For example, the quality index model of the first kind is obtained by training a machine learning algorithm, with the number of inter partes activities forming part of the training data, preferably together with the first plurality of IP disclosures of the first kind.

In an aspect of the 16^{th} embodiment, it is preferred that the at least one IP product is labelled with the at least one quality index of the first kind by using the number of inter partes activities (step c. in the 1^{st} embodiment). For example, the number of inter partes activities is used as input in the at least one quality index model of the first kind.

In a preferred embodiment of the computer-implemented method, the method further comprises the steps of
a. providing at least one classification;
b. optionally, obtaining a first plurality of IP disclosures of the first kind, wherein at least 80%, preferably at least 95% of said IP disclosures of the first kind have been classified with the at least one classification;
c. optionally, obtaining the number of inter partes activities of the first plurality of IP disclosures of the first kind;
d. identifying at least one entity that owns at least one IP disclosure of the first kind, preferably at least one IP disclosure of the first kind that has been classified according to the at least one classification;
e. obtaining a further plurality of IP disclosures of the first kind that are owned by the at least one entity.

This preferred embodiment is a 17^{th} embodiment of the invention, that preferably depends on any of the 1^{st} to 15^{th} embodiments of the invention. In an aspect of the 17^{th} embodiment, it is preferred that the at least one IP product is classified with the same classification(s) as the first plurality of IP products of the first kind. In a preferred aspect of the 17^{th} embodiment, it is preferred that the steps a. to e. in the 17^{th} embodiment is performed prior to step a. in the 1^{st} embodiment.

Examples of the at least one classification in the 17^{th} embodiment are given in the 9^{th} embodiment of the invention, and in the preferred aspects of the 9^{th} embodiment. In an aspect of the 17^{th} embodiment, it is preferred that the first plurality of IP disclosures of the first kind have been classified using a classification model, more preferably using the classification model according to the invention.

In an aspect of the 17^{th} embodiment, it is preferred that the at least one quality index model of the first kind is obtained (step a. in the 1^{st} embodiment) using the further plurality of IP disclosures of the first kind, the number of inter partes activities, the first plurality of IP disclosures of the first kind, or a combination of at least two thereof. For example, the quality index model of the first kind is obtained by training a machine learning algorithm, with the further plurality of IP disclosures of the first kind forming part of the training data, preferably together with the number of inter partes activities and/or the first plurality of IP disclosures of the first kind.

In an aspect of the 17^{th} embodiment, it is preferred that the at least one IP product is labelled with the at least one quality index of the first kind by using the further plurality of IP disclosures of the first kind, the number of inter partes activities, or both (step c. in the 1^{st} embodiment). For example, further plurality of IP disclosures of the first kind and the number of inter partes activities is used as input in the at least one quality index model of the first kind.

In a preferred embodiment of the computer-implemented method, the method further comprises at least one or all of the following steps:
f. determining an overlap between the first plurality of IP disclosures of the first kind and the further plurality of IP disclosures of the first kind;
g. determining if the at least one entity is a patent assertion entity;
h. determining the remaining lifetime of an IP disclosure of the first kind that has been subjected to at least one inter partes activity;
i. determining a patent assertion entity density.

This preferred embodiment is an 18^{th} embodiment of the invention, that preferably depends on the 17^{th} embodiment of the invention. In an aspect of the 18^{th} embodiment, all possible combination of the features f. to i. are preferred aspects of the embodiment. These combinations are e.g., f, g; h; i; f, g; f, h; f, i; g, h; g, i; h, i; f, g, h; f, g, i; f, h, i; g, h, i; f, g, h, i. In an aspect of the 18^{th} embodiment, it is preferred to perform one or more of the steps f. to i. after step c. in the 17^{th} embodiment, and preferably prior to step a. in the 1^{st} embodiment. In an aspect of the 18^{th} embodiment, it is preferred to perform one or more of the steps f. to i. after step e. in the 17^{th} embodiment, and preferably prior to step a. in the 1^{st} embodiment.

In an aspect of the 18^{th} embodiment, feature f., the overlap is preferably determined by calcu-lating the number of IP disclosures of the first kind that form part of both the first plurality of IP disclosures of the first kind and the further plurality of IP disclosures of the first kind. In an aspect of the 18^{th} embodiment, feature i., the patent assertion entity density, pip, is preferably obtained as follows

$$\\ {ρ}_{IP} , = {N}_{PAE} / {N}_{IP} ,$$

where N_{PAE} is the number of IP disclosures of the first kind (forming part of the first plurality of IP disclosures of the first kind and/or the further plurality of IP disclosures of the first kind) that is subjected to at least one inter partes activity and which are owned by a patent assertion entity, and NIP, is the total number of IP disclosures of the first kind (forming part of the first plurality of IP disclosures of the first kind and/or the further plurality of IP disclosures of the first kind) that is subjected to at least one inter partes activity. The IP disclosures of the first kind forming part of N_{PAE} and Nip preferably all have the same classification.

In an aspect of the 18^{th} embodiment, it is preferred that the at least one quality index model of the first kind is obtained (step a. in the 1^{st} embodiment) using at least one or all of following: the overlapping IP disclosures of the first kind, whether the at least one entity is a patent assertion entity, the remaining lifetime of an IP disclosure of the first kind that has been subjected to at least one inter partes activity, the patent assertion entity density, or a combination of at least two or more thereof. For example, the quality index model of the first kind is obtained by training a machine learning algorithm, with the overlapping IP disclosures of the first kind forming part of the training data.

In a preferred embodiment of the computer-implemented method, the method further comprises the step of providing a plurality of IP disclosures of a further kind. This preferred embodiment is a 19^{th} embodiment of the invention, that preferably depends on any of the 1^{st} to 18^{th} embodiments of the invention. In an aspect of the 19^{th} embodiment, it is preferred that the plurality of IP disclosures of the further kind comprise text data. In a further aspect of the 19^{th} embodiment, it is preferred that the plurality of IP disclosures of the further kind are provided before, after, or at least partially simultaneously with performing at least one or all of the steps a. to d., more preferably steps a. to b., in the 1^{st} embodiment.

In a preferred embodiment of the computer-implemented method, the plurality of IP disclosures of the further kind are classified according to the at least one classification. This preferred embodiment is a 20^{th} embodiment of the invention, that preferably depends on the 19^{th} embodiment of the invention.

In a preferred embodiment of the computer-implemented method, the classification model is obtained using the plurality of IP disclosures of the further kind, preferably using the text data of at least one, more preferably at least 50%, further preferably all, of the plurality of IP disclosures of the further kind. This preferred embodiment is a 21^{st} embodiment of the invention, that preferably depends on any of the 19^{th} to 20^{th} embodiments of the invention.

In a preferred embodiment of the computer-implemented method, the plurality of IP disclosures of the further kind is classified by at least one or all of the following:
a. a human operator;
b. machine learning;
c. artificial intelligence.

This preferred embodiment is a 22^{nd} embodiment of the invention, that preferably depends on any of the 20^{th} to 21^{st} embodiments of the invention. In an aspect of the 22^{nd} embodiment, all possible combination of the features a. to c. are preferred aspects of the embodiment. These combinations are e.g., a; b; c; a, b; a, c; b, c; a, b, c.

In a preferred embodiment of the computer-implemented method, at least one or all of the following applies:
a. the plurality of IP disclosures of the first kind comprises in the range of 100 to 1 000 000, preferably in the range of 1 000 to 500 000, and more preferably in the range of 10 000 to 100 000 IP disclosures of the first kind;
b. the plurality of IP disclosures of the further kind comprises in the range of 100 to 1 000 000, preferably in the range of 1 000 to 500 000, and more preferably in the range of 10 000 to 100 000 IP disclosures of the further kind.

This preferred embodiment is an 23^{rd} embodiment of the invention, that preferably depends on any of the 1^{st} to 22^{nd} embodiments of the invention. In an aspect of the 23^{rd} embodiment, all possible combination of the features a. and b. are preferred aspects of the embodiment. These combinations are e.g., a; b; a, b.

In a preferred embodiment of the computer-implemented method, the method further comprises the steps of
a. obtaining at least one quality index model of the further kind;
b. labelling the at least on IP product, using the at least one quality index model of the further kind, with at least one quality index of the further kind.

This preferred embodiment is a 24^{th} embodiment of the invention, that preferably depends on any of the 1^{st} to 23^{rd} embodiments of the invention. In an aspect of the 24^{th} embodiment, it is preferred that at least one or all of the features in at least one or all of the 11^{th} to 13^{th} embodiments of the invention apply, mutatis mutandis, to the obtaining of the at least one quality index model of the further kind. E.g., the at least one quality index model of the further kind is obtained using at least one or all of the following: machine learning, artificial intelligence. In this aspect, it is more preferred that at least one or all of the preferred aspects of the 11^{th} to 13^{th} embodiments of the invention apply, mutatis mutandis, to the obtaining of the at least one quality index model of the further kind. In an aspect of the 24^{th} embodiment, it is preferred that the at least one quality index model of the further kind is obtained either before, after, or at least partially simultaneously with, performing at least one or all of the steps a. to d. in the 1^{st} embodiment. In another aspect of the 24^{th} embodiment, it is preferred that the at least one IP product is labelled with the at least one quality index of the further kind, either before, after, or at least partially simultaneously with the labelling of the at least one IP product with the quality index of the first kind.

In a preferred embodiment of the computer-implemented method, the at least one quality index model of the further kind is obtained using at least one or all of the following:
a. the plurality of IP disclosures of the first kind;
b. the plurality of IP disclosures of the further kind;

This preferred embodiment is a 25^{th} embodiment of the invention, that preferably depends on the 24^{th} embodiment of the invention. In an aspect of the 25^{th} embodiment, all possible combination of the features a. and b. are preferred aspects of the embodiment. These combinations are e.g., a; b; a, b.

In a preferred embodiment of the computer-implemented method, the at least one quality index of the further kind is based on at least one or all of the following:
a. a citation measure, preferably a mean value of the citation measure, more preferably a rate of change of the citation measure;
b. a market measure, preferably a mean value of the market measure, more preferably a rate of change of the market measure;
c. a composite measure, preferably a mean value of the composite measure, more preferably a rate of change of the composite measure;
d. an aggregate measure, preferably a mean value of the aggregate measure, more preferably a rate of change of the aggregate measure.
e. a combination of two or more of the above.

This preferred embodiment is a 26^{th} embodiment of the invention, that preferably depends on any of the 24^{th} to 25^{th} embodiments of the invention. In an aspect of the 26^{th} embodiment, all possible combination of the features a. to e. are preferred aspects of the embodiment. These combinations are e.g., a; b; c; d; e; a, b; a, c; a, d; a, e; b, c; b, d; b, e; c, d; c, e; d, e; a, b, c; a, b, d; a, b, e; a, c, d; a, c, e; a, d, e; b, c, d; b, c, e; b, d, e; c, d, e; a, b, c, d; a, b, c, e; a, b, d, e; a, c, d, e; b, c, d, e; a, b, c, d, e. In an aspect of the 26^{th} embodiment, it is preferred that at least one or all of the features a. to e. are used as input (e.g., parameters) in the at least one quality index model of the further kind in order to obtain the at least one quality index of the further kind that the at least one IP product is labelled with.

In a further aspect of the 26^{th} embodiment, it is preferred that a mean value for the citation measure is calculated by determining a citation measure for each IP product comprised in a plurality of IP products, and averaging over all the citation measures. In this aspect, it is preferred that the plurality of IP products are owned by the same entity or entities. In another aspect of the 26^{th} embodiment, it is preferred that the preferred embodiments that apply to the mean value of the citation measure apply, mutatis mutandis, to at least one or all of the following: the mean value of the market measure, the mean value of the composite measure, and the mean value of the aggregate measure. In an aspect of the 26^{th} embodiment, it is preferred that the rate of change of the citation measure is calculated using a plurality of IP products that are owned by the same entity or entities. In another aspect of the 26^{th} embodiment, it is preferred that the preferred embodiment that applies to the rate of change of the citation measure apply, mutatis mutandis, to at least one or all of the following: the mean value of the market measure, the mean value of the composite measure, and the mean value of the aggregate measure.

In a preferred embodiment of the computer-implemented method, the method further comprises the step of determining at least one entity that owns at least one, preferably at least two, more preferably at least 10, and further preferably at least 50 IP products. This preferred embodiment is a 27^{th} embodiment of the invention, that preferably depends on any of the 1^{st} to 26^{th} embodiments of the invention. In an aspect of the 27^{th} embodiment, it is preferred that at least one, preferably all, IP products owned by the at least one entity are labelled with the at least one quality index of the first kind. In another aspect of the 27^{th} embodiment, it is preferred that at least one, preferably all, IP products owned by the at least one entity are labelled with the at least one quality index of the further kind. In an aspect of the 27^{th} embodiment, it is preferred that the at least one entity is determined before, after, or at least partially simultaneously with performing at least one or all of the steps c. to d. in the 1^{st} embodiment.

In a preferred embodiment of the computer-implemented method, the method further comprises the step of labelling the at least one entity with an economic index. This preferred embodiment is a 28^{th} embodiment of the invention, that preferably depends on the 27^{th} embodiment of the invention. In an aspect of the 28^{th} embodiment, it is preferred that the at least one entity is labelled with an economic index using an economic index model. In this aspect it is preferred to obtain the economic index model prior to labelling the at least one entity with the economic index.

In a preferred embodiment of the computer-implemented method, the economic index is based on at least one or all of the following:
a. a market capitalisation of the at least one entity;
b. a financial result of the at least one entity, e.g., a turn-over of a previous year, dividends paid out;
c. a likelihood of financial growth of the at least one entity, e.g., an increase in turn-over, an increase in profit;
d. a likelihood that the at least one entity will expand into other markets, e.g., new countries, new regions, the production of new products;
e. a likelihood that the at least one entity will continue a product, activity, or both;
f. an amount of money spent on research and development, e.g., of at least one technical product, at least one technical activity, or both.

This preferred embodiment is a 29^{th} embodiment of the invention, that preferably depends on the 28^{th} embodiment of the invention. In an aspect of the 29^{th} embodiment, all combinations of the features a. to f. are preferred aspects of the embodiment. These combinations are e.g., a; b; c; d; e; f; a, b; a, c; a, d; a, e; a, f; b, c; b, d; b, e; b, f; c, d; c, e; c, f; d, e; d, f; e, f; a, b, c; a, b, d; a, b, e; a, b, f; a, c, d; a, c, e; a, c, f; a, d, e; a, d, f; a, e, f; b, c, d; b, c, e; b, c, f; b, d, e; b, d, f; b, e, f, c, d, e; c, d, f; c, e, f; d, e, f; a, b, c, d; a, b, c, e; a, b, c, f; a, b, d, e; a, b, d, f; a, b, e, f; a, c, d, e; a, c, d, f; a, c, e, f; a, d, e, f; b, c, d, e; b, c, d, f; b, c, e, f; b, d, e, f; c, d, e, f; a, b, c, d, e; a, b, c, d, f; a, b, c, e, f; a, b, d, e, f; a, c, d, e, f; b, c, d, e, f; a, b, c, d, e, f. In an aspect of the 29^{th} embodiment, it is preferred that at least one or all of the features a. to f. are used as input (e.g., parameters) in an economic index model in order to obtain the economic index that the at least one entity is labelled with.

In a preferred embodiment of the computer-implemented method, the indicator is obtained using the at least one quality index of the first kind together and at least one or all of the following:
a. the quality index of the further kind;
b. the economic index.

This preferred embodiment is a 30^{th} embodiment of the invention, that preferably depends on any of the 24^{th} to 29^{th} embodiments of the invention. In an aspect of the 30^{th} embodiment, all possible combination of the features a. and b. are preferred aspects of the embodiment. These combinations are e.g., a; b; a, b.

A 31^{st} embodiment of the invention is a computer-implemented method for producing an indicator, wherein the method comprises the steps of
a. obtaining a first quality index model of the first kind;
b. obtaining a further quality index model of the first kind;
c. providing at least one IP product;
d. labelling the at least one IP product, using the first quality index model of the first kind, with a first quality index of the first kind;
e. labelling the at least one IP product, using the further quality index model of the first kind, with a further quality index of the first kind;
f. obtaining the indicator using the first quality index of the first kind and the further quality index of the first kind;
wherein
   the at least one IP product is labelled with the first quality index of the first kind, the further quality index of the first kind, or both, independently of at least one other IP product.

In an aspect of the 31^{st} embodiment, it is preferred that any of the 1^{st} to 30^{th} embodiments, and their preferred aspects, apply mutatis mutandis to the 31^{st} embodiment. In an aspect of the 31^{st} embodiment, it is preferred that the first quality index model of the first kind and the further quality index model of the first kind are different. For example, the first quality index model of the first kind is used for obtaining a prediction of the likelihood of grant of the at least one IP product, whereas the further quality index model of the first kind is used to obtain a likelihood that the IP product will receive a certain number of citations. In an aspect of the 31^{st} embodiment, the method further comprises the step of obtaining at least one additional quality index model of the first kind. In this aspect, it is preferred that the first quality index model of the first kind, the further quality index model of the first, and the at least one additional quality index model of the first kind are all different with respect to each other.

A 32^{nd} embodiment of the invention is an indicator obtainable by a method, according to the invention, for producing an indicator, preferably an indicator obtainable by the method according to any of the 1^{st} to 31^{st} embodiments of the invention.

A 33^{rd} embodiment of the invention is a first data processing device comprising means for carrying out a least some of the steps of a method, according to the invention, for producing an indicator, preferably the steps of the method according to any of the 1^{st} to 31^{st} embodiments of the invention, wherein the first data processing device comprises at least one or all of the following:
a. at least one processing unit, e.g., a central processing unit (CPU);
b. at least one display device, e.g., a screen;
c. at least one input device, e.g., a keyboard, a mouse;
d. at least one primary storage medium, e.g., random access memory;
e. at least one secondary storage medium, e.g., random access memory (RAM); and
wherein at least one or all of the following applies to the first data processing device:
I./ the at least one processing unit has a clock rate that is less than 6 GHz, preferably less than 5 GHz, more preferably less than 4 GHZ, even more preferably less than 3 GHZ, and even further preferably less than 2 GHZ;
II./ the at least one primary storage medium has less than 8 Gb, preferably less than 6 Gb, more preferably less than 4 Gb, and further preferably less than 2 Gb of storage space.

In an aspect of the 33^{rd} embodiment, all possible combination of the features a. to e. are preferred aspects of the embodiment. These combinations are e.g., a; b; c; d; e; a, b; a, c; a, d; a, e; b, c; b, d; b, e; c, d; c, e; d, e; a, b, c; a, b, d; a, b, e; a, c, d; a, c, e; a, d, e; b, c, d; b, c, e; b, d, e; c, d, e; a, b, c, d; a, b, c, e; a, b, d, e; a, c, d, e; b, c, d, e; a, b, c, d, e. In an aspect of the 33^{rd} embodiment, all possible combination of the features I./ and II./ are preferred aspects of the embodiment. These combinations are e.g., I./; II./; I./, II./. In an aspect of the 33^{rd} embodiment, all possible combination of the features I./ and II./ are preferred aspects of the embodiment. These combinations are e.g., I./; II./; I./, II./. In an aspect of the 33^{rd} embodiment, it is preferred that the first data processing device comprises a network card. In another aspect of the 33^{rd} embodiment, it is preferred that the first data processing device does not comprise a graphics processing unit. In an aspect of the 33^{rd} embodiment, it is preferred that the first data processing device does not comprise means for obtaining a model according to the invention (e.g., the at least one quality index model of the first kind, the at least one quality index model of the further kind, the classification model) using either artificial intelligence, machine learning, or both. E.g., the first data processing device does not comprise means for performing the method according to the 11^{th} to 13^{th} embodiments of the invention. Rather, the model is obtained by, e.g., downloading the model from the Internet or copying the model from computer storage, such as a flash drive.

In a preferred embodiment of the first data processing device, either of the following applies:
a. the first data processing device is connected to a computer network with a data transfer rate that is less than 10 Mbps, preferably less than 5 Mbps, more preferably less than 2 Mbps, and further preferably less than 1 Mbps;
b. the first data processing device is not connected to a computer network.

This preferred embodiment is a 34^{th} embodiment of the invention, that preferably depends on the 33^{rd} embodiment of the invention.

In a preferred embodiment of the first data processing device, the first data processing device is selected from the group consisting of a computer, a laptop, a smart phone, and a tablet. This preferred embodiment is a 35^{th} embodiment of the invention, that preferably depends on any of the 33^{rd} to 34^{th} embodiments of the invention.

A 36^{th} embodiment of the invention is a further data processing device comprising means for carrying out the steps of a method, according to the invention, for producing an indicator, preferably the method according to any of the 1^{st} to 31^{st}, embodiments of the invention, wherein the further data processing device comprises at least one or all of the following:
a. at least one processing unit, e.g., a central processing unit, a graphics processing unit;
b. at least one display device, e.g., a screen;
c. at least one network card;
d. at least one input device, e.g., a keyboard, a mouse;
e. at least one primary storage medium, e.g., random access memory;
f. at least one secondary storage medium, e.g., a hard drive.

In an aspect of the 36^{th} embodiment, all possible combination of the features a. to f. are preferred aspects of the embodiment. These combinations are e.g., a; b; c; d; e; f; a, b; a, c; a, d; a, e; a, f; b, c; b, d; b, e; b, f; c, d; c, e; c, f; d, e; d, f; e, f; a, b, c; a, b, d; a, b, e; a, b, f; a, c, d; a, c, e; a, c, f; a, d, e; a, d, f; a, e, f; b, c, d; b, c, e; b, c, f; b, d, e; b, d, f; b, e, f; c, d, e; c, d, f; c, e, f; d, e, f; a, b, c, d; a, b, c, e; a, b, c, f; a, b, d, e; a, b, d, f; a, b, e, f; a, c, d, e; a, c, d, f; a, c, e, f; a, d, e, f; b, c, d, e; b, c, d, f; b, c, e, f; b, d, e, f; c, d, e, f; a, b, c, d, e; a, b, c, d, f; a, b, c, e, f; a, b, d, e, f; a, c, d, e, f; b, c, d, e, f; a, b, c, d, e, f.

In a preferred embodiment of the further data processing device, the further data processing device is selected from the group consisting of a computer cluster, a computer, and a laptop. This preferred embodiment is a 37^{th} embodiment of the invention, that preferably depends on the 36^{th} embodiment of the invention.

A 38^{th} embodiment of the invention is a computer program comprising instructions which, when the program is executed by a computer, causes the computer to carry out the steps of a method, according to the invention, for producing an indicator, preferably the method according to of any of the 1^{st} to 31^{st} embodiments of the invention.

In an aspect of the 38^{th} embodiment, it is preferred that the computer program forms part of a container, e.g., a Docker container (Docker Inc, USA). For example, the computer program is executed using a container.

A 39^{th} embodiment of the invention is a computer-readable data carrier having stored thereon a computer program according to the invention, preferably the computer program according to the 38^{th} embodiment of the invention.

A 40^{th} embodiment of the invention is a use of at least one or all of the following to obtain an indicator, preferably an indicator according to the invention, and more preferably the indicator according to the 32^{nd} embodiment of the invention:
a. at least one quality index of the first kind, preferably the at least one quality index of the first kind according to the invention, more preferably the at least one quality index of the first kind according to any of the 1^{st} to 31^{st} embodiments of the invention;
b. at least one quality index of the further kind, preferably the at least one quality index of the further kind according to the invention, more preferably the at least one quality index of the further kind according to any of 24^{th} to 31^{st} embodiments of the invention;
c. an economic index, preferably the economic index according to the invention, and more preferably the economic index according to any of the 28^{th} to 31^{st} embodiments of the invention;
d. at least one classification, preferably the at least one classification according to the invention, and more preferably the at least one classification according to any of the 6^{th} to 31^{st} embodiments of the invention.

In an aspect of the 40^{th} embodiment, all possible combination of the features a. to d. are preferred aspects of the embodiment. These combinations are e.g., a; b; c; d; a, b; a, c; a, d; b, c; b, d; c, d; a, b, c; a, b, d; a, c, d; b, c, d; a, b, c, d.

A 41^{st} embodiment of the invention is process for making a business decision, comprising the steps of:
a. providing an indicator according to the invention, preferably either an indicator according to the 32^{nd} embodiment of the invention, or an indicator obtainable by a method, according to the invention, for producing an indicator, more preferably the method according to any of the 1^{st} to 31^{st} embodiments of the invention;
b. displaying the indicator using at least one or all of the following: at least one screen of a computer, at least one screen of a laptop, at least one screen of a tablet, at least one screen of a smart phone, a projector, or a combination of two or more thereof.

### DETAILED DESCRIPTION OF THE INVENTION

Throughout this document, disclosures of ranges should preferably be understood to include both end points of the range. Furthermore, each disclosure of a range in the document should preferably be understood as also disclosing preferred sub-ranges in which one end point is excluded or both end points are excluded. For example, a disclosure of a range from 2 GHz to 4 GHz is to be understood as disclosing a range that includes both of the end points 2 GHz and 4 GHz. Furthermore, it is to be understood as also disclosing a range that includes the end point 2 GHz but excludes the end point 4 GHz, a range that excludes the end point 2 GHz but includes the end point 4 GHZ, and a range that excludes both end points 2 GHz and 4 GHz.

In this disclosure, an “IP right” is used as a collective term for an IP product and an IP disclosure. Any aspect or embodiment that refers to an IP right should thus preferably be understood to mean that the aspect or embodiment applies to either an IP product, or an IP disclosure, or both. This should, however, not be understood to mean that the aspect or embodiment only applies to a combination of an IP product and an IP disclosure.

### IP Disclosures and IP Products

An “IP disclosure” should preferably be understood to mean a disclosure, related to intellectual property, that has been made available to at least one member of the public by means of a written or oral description, by use, or in any other way, e.g., a disclosure that falls under Art. 54 (2) EPC. An “IP disclosure” preferably includes at least a part of at least one or all of the following: a patent application, a patent, a utility model, or a utility certificate. Examples of an “IP disclosure” are at least one or all of the following: from a patent—at least one granted claim, a patent specification, abstract, at least one figure, or a combination of at least two thereof; from a patent application—at least one claim, a description, an abstract, at least one figure, or a combination of at least two thereof; an invention disclosure, for example an invention disclosure published on the internet; an invention that has been displayed at an exhibition; or a combination of at least two thereof.

A “plurality of IP disclosures of the first kind” should preferably be understood to mean a set or a collection of IP disclosures, wherein each member of the set is referred to as an “IP disclosure of the first kind”. A “plurality of IP disclosure of the first kind” should preferably also be understood to mean IP disclosures that are used to obtain a quality index model of the first kind. E.g., multiple first quality index models are trained using machine learning, and a different set of IP disclosures are used to train each first quality index model. Each of these sets are referred to as “a plurality of IP disclosure of the first kind”. In aspect of the invention, it is preferred that an “IP disclosure of the first kind” is classified according to at least one classification.

A “plurality of IP disclosures of the further kind” should preferably be understood to mean a set or a collection of IP disclosures, wherein each member of the set is referred to as an “IP disclosure of the further kind”. An “IP disclosure of the further kind” should preferably also be understood to mean an IP disclosure that is not classified according to at least one classification. E.g., a first quality index model is trained using machine learning. If the “plurality of IP disclosures of the first kind” are not classified according to at least one classification, then the “plurality of IP disclosures of the first kind” is equivalent to a “plurality of IP disclosures of the further kind”.

In aspect of the invention, it is preferred that a plurality of IP disclosure of the first kind is obtained by classifying a plurality of IP disclosure of the further kind according to at least one classification. E.g., a first quality index model is trained using machine learning. The plurality of IP disclosures of the first kind are obtained by classifying the plurality of IP disclosures of the further kind according to at least one classification. It is preferred that this aspect does not necessarily imply that all the IP disclosures that form the plurality of IP disclosure of the further kind also from part of the plurality of IP disclosure of the first kind. E.g., a plurality of IP disclosure of the further kind are classified according to two classifications, i.e., a first and a further plurality of IP disclosure of the first kind are obtained, i.e., two sets of classified IP disclosures. After classification, an IP disclosure, which was part of the plurality of IP disclosures of the further kind, may form part of one, both, or none of the sets.

An “IP product” should preferably be understood to mean at least one or all of the following: an IP disclosure, a potential IP disclosure, or a combination thereof. A potential IP disclosure should preferably be understood to mean intellectual property that could possibly be made available to the public at a future date, e.g., a draft of a claim which may form part of a patent application that will be filed in the future; a draft of a partial claim which may form part of a patent application that will be filed in the future; a draft of a description which may form part of a patent application that will be filed in the future; a draft of a partial description which may form part of a patent application that will be filed in the future; a patent application, including claims, description, and figures, which has been completed, but not yet filed; a patent application that has been filed, but which has not yet been published; an invention disclosure; a dis-tinct example of a technology, such as a recipe, a formulation, a chemical procedure; a literal description of a technical drawing; or a combination of two or more thereof.

In an aspect of the invention, it is preferred that an IP disclosure is also an IP product. E.g., a published patent application is both an IP disclosure and an IP product.

### Text Data and Numerical Data

“Text data” of an IP right should preferably be understood to mean the cognitive content of an IP right. Examples of “text data” include a description of a patent application, a paten specification, one or more claims of a patent or a patent application, an abstract of a patent or a patent application, an invention disclosure, a scientific article, parts thereof (e.g., a partial claim), or a combination of two or more thereof.

In contrast, “mimerical data” of the IP right should preferably be understood to mean metadata of the IP right. Examples of “mimerical data” include the filing date of a patent and/or a patent application, the number of claims that a patent and/or a patent application contains, the number of citations to a patent and/or a patent application, the countries in which a patent and/or a patent application has been filed, whether a patent has been granted for a patent application, the number of inventors listed on a patent and/or a patent application, the claim length of a claim in a patent and/or a patent application, or a combination of two or more thereof.

### Quality Index Models and Quality Indices

In an aspect of the invention, it is particularly preferred that labelling an IP product with the at least one quality index of the first kind comprises the step of using at least the text data, and optionally the numerical data, of the IP product as input in the at least one quality index model of the first kind. In an aspect of the invention, it is particularly preferred that labelling an IP product with the at least one quality index of the further kind comprises the step of using either the text data, or the numerical data, or both, of the IP product as input in the at least one quality index model of the further kind.

In an aspect of the invention, it is particularly preferred that labelling the IP product with the at least one quality index of the first kind comprises the step of using at least one or all of the following as input in the at least one quality index model of the first kind: the text data of the IP product, the vectorized text data of the IP product, or a combination thereof. In this aspect, it is preferred to also use the numerical data of the IP product as input in the at least one quality index model of the first kind. In an aspect of the invention, it is particularly preferred that labelling the IP product with the at least one quality index of the further kind comprises the step of using at least one or all of the following as input in the at least one quality index model of the further kind: the text data of the IP product, the vectorized text data of the IP product, the numerical data of the IP product, or a combination of at least two thereof.

In an aspect of the invention, it is preferred that the quality index model of the first kind is not used to classify an IP right. For example, the quality index model of the first kind is not used to determine the field of technology of an IP product, e.g., whether the IP product falls within either of the fields of “recycling of plastics” or “food technology”. In an aspect of the invention, it is preferred that the quality index model of the further kind is not used to classify an IP right.

Examples of a quality index of the first kind that an IP product is labelled with include the following: the IP product is a claim of a patent application, and the quality index of the first kind is a likelihood of grant of the claim; the IP product is a description of an invention (e.g., invention disclosure), and the quality index of the first kind is a likelihood of grant of a claim that pertains to the invention.

In an aspect of the invention, it is preferred that the quality index model of the first kind is obtained using machine learning techniques, models, or both, adapted and arranged for natural language processing. Examples of these models or techniques include: BERT, GPT-1, GPT-2, GPT-3, Sentence-BERT, BERT base, BERT large, DistilBERT, ROBERTa, Big Bird, XLNet, REFORMER, LONGFORMER, ALBERT, ELECTRA, BART, and T5. These examples are well-known to the person skilled in the art. Further examples include Keras and TensorFlow.

In an aspect of the invention, if the quality index of the first kind is a likelihood of grant of an IP product, it is preferred that the quality index model of the first kind, used to obtain the likelihood of grant, is obtained using the text data of the IP disclosures of the first kind, more preferably IP disclosures of the first kind that have been classified according to at least one classification. In this aspect, it is preferred that the text data of the IP product is used as input to obtain the likelihood of grant. In this aspect it is preferred to use a BERT algorithm to obtain the quality index model of the first kind.

In an aspect of the invention, if the quality index of the first kind is a likelihood of a number of citations to an IP product, it is preferred that the quality index model of the first kind, used to obtain the likelihood of a number of citations, is obtained using at least one text vector of the text data of the IP disclosures of the first kind. In this aspect, it is preferred that the at least one text vector of the text data of the IP product is used as input to obtain the likelihood of a number of citations. In this aspect it is preferred to use a deep neural network algorithm to obtain the quality index model of the first kind.

A “citation measure” should preferably be understood to mean a measure of the number of citations, more preferably forward citations, received by at least one IP product (e.g., a patent or patent application). It is preferred that the “citation measure” corrects for at least one or all of the following: an IP product's age, different citation propensities that are observed in different technology fields, different citation propensities that are observed amongst the different national and multinational patent offices, or a combination of two or more thereof.

A “forward citation” of an IP right should preferably be understood as the citation of the IP right by another IP right. A forward citation of a first IP right by a further IP right means that the further IP right cites the first IP right.

A “market measure” should preferably be understood to mean a measure of a market size of at least one IP product's scope of protection. It is preferred that the “market measure” is calculated as a sum of the authorities' gross national income for all those countries where patent protection is sought for, relative to the gross national income of the USA.

A “composite measure” is preferably determined by taking into account a patent family's (comprising at least one IP product) citation measure and market measure. A “aggregate measure” is preferably determined by summing up the individual composite measure of all patent families (comprising at least one IP product) belonging to a patent portfolio of an entity.

Further information on the citation measure, the market measure, the composite measure, and the aggregate measure can be found in: Ernst, H. and Omland, N. (2011), “The Patent Asset Index—A new approach to benchmark patent portfolios”, World Patent Information, Vol. 33, No. 1, pages 34-41; Guderian, C. C. (2019), “Identifying Emerging Technologies with Smart Patent Indicators: The Example of Smart Houses”, International Journal of Innovation and Technology Management, Vol. 16, No. 2, 1950040.

An example of the citation measure is a Technology Relevance™. An example of a market measure is a Market Coverage™. An example of a composite measure is a Competitive Impact™. An example of an aggregate measure is a Patent Asset Index™. The Technology Relevance™, Market Coverage™, Competitive Impact™. and Patent Asset Index™ are commer-cially available from PatentSigth GmbH (Germany).

### Vectorization

The term “vectorization” should preferably be understood as the conversion of text data into a numerical representation. The vectorization preferably leads to the obtaining of at least one text vector. It is preferred that the meaning of the text data forms part of the text vector. Examples of “vectorization” methods include Bag of Words, Term Frequency-Inverse Document Frequency, Word2Vec, Global Vectors, and FastText, and transformer models. Software suitable to perform the vectorization are well-known to the skilled person and include, e.g., the SentenceTransformers framework, available from https://github.com/UKPLab/sentence-transformers/blob/master/index.rst, and described in Reimers and Gurevych (2019), “Sentence-BERT: Sentence Embeddings using Siamese BERT-Networks”, arXiv: 1908.10084.

### The at Least One Classification and the Classification Model

The “classifying” of an IP right should preferably be understood to mean that the IP right is classified according to at least one or more “classifications”. E.g., a patent pertaining to a solar panel is classified as belonging to the classification “green energy”. E.g., a patent application pertaining to an autonomous, electrical vehicle is classified as belonging to the classifications “green energy” and “autonomous vehicles”.

In an aspect of the invention, it is preferred that the “at least one classification” is based on at least one concrete concept, as opposed to at least one abstract concept. E.g., a classification is chosen as “truck” (concrete), instead of “means of transportation” (abstract). E.g., a classification is chosen as “method for recycling polyethylene terephthalate” (concrete), instead of “process for producing a reclaimed product” (abstract).

The “classification model” should preferably be understood to mean a model, such as a computer algorithm or computer program, that classifies an IP right according to at least one classification.

If a model (e.g., a classification model, a quality index model of the first kind, a quality index model of the further kind, an economic index model) is based on at least one classification, this should preferably be understood to mean that the model was obtained by taking into account the at least one classification. E.g., four classifications are provided, and a separate quality index model of the first kind is derived for each classification, i.e., four quality index models of the first kind are derived.

### The Indicator

An “indicator” should preferably be understood to mean a value that provides a human with a measure, gauge, likelihood, or hint of a quality (e.g., likelihood of grant, monetary value, likelihood of a number of citations, the likelihood of an inter partes activity) of an IP product, a quality of an entity that owns at least one IP product, or both.

Examples of a quality of an entity that owns at least one IP product include the following: a company owns a patent portfolio that comprises at least one, preferably multiple, patents, patent applications, utility models, utility model applications, or a combination of two or more thereof. The quality of the entity indicates either a strength of the entity's patent portfolio compared to a different entity's patent portfolio, or a prediction how the strength of the entity's patent portfolio will develop over time, or both.

In a further aspect of the invention, it is preferred that a quality index of the first kind is the indicator. In an aspect of the invention, it is preferred that at least one or all of the following is used as input in a mathematical model, wherein the indicator is obtained as a solution of the mathematical model: the at least one quality index of the first kind, the at least one quality index of the further kind, the economic index.

In an aspect of the invention, it is preferred that the indicator is obtained by using at least one of the features of group (A) below together with at least one of the features of group (B) below:

(A)
A1. at least one quality index of the first kind of at least one IP product, wherein the at least one IP product is owned by at least one first entity;
A2. at least one quality index of the further kind of at least one IP product, wherein the at least one IP product is owned by the at least one first entity;
A3. an economic index of the at least one first entity;

(B)
B1. at least one quality index of the first kind of at least one IP product, wherein the at least one IP product is owned by at least one further entity;
B2. at least one quality index of the further kind of at least one IP product, wherein the at least one IP product is owned by the at least one further entity;
B3. an economic index of the at least one further entity.

In the above aspect, it is further preferred that the indicator is obtained by comparing at least one of the features of group (A) above together with at least one of the features of group (B) above.

### Miscellaneous

A “model” (e.g., a classification model, a quality index model of the first kind, a quality index model of the further kind, an economic index model) should preferably be understood to mean an algorithm. In this aspect it is preferred that the algorithm forms part of software, e.g., a computer program. A preferred algorithm uses input (e.g., the at least one IP product) to generate output (e.g., the at least quality index of the first kind). A preferred algorithm is based on at least one mathematical formula.

The “obtaining” of a model (e.g., a classification model, a quality index model of the first kind, a quality index model of the further kind, an economic index model) preferably includes at least one or all of the following: the model is provided by a 3^{rd} party, the model is download from a network, e.g., the Internet, the model is produced using a computer algorithm (e.g., using a machine learning algorithm), the model is derived from data (e.g., deriving a mathematical equation), the model is obtained by querying a database, the model is obtained by reading a storage medium (e.g., a hard disk or RAM), or a combination of two or more thereof.

An “entity” should preferably be understood to mean at least one natural person (e.g., an inventor or an employee working for a company), at least one legal entity, at least one company, at least one country, at least one region (e.g., countries that have ratified the European Patent Convection, a continent), or a combination of two or more thereof.

A “patent assertion entity” is preferably understood to be an entity that owns at least one IP right, preferably at least one IP disclosure of the first kind, but does not produce a product, or performs a method for producing a product. For example, a hedge fund or a patent “troll” may own a patent, but these entities do not produce a product, or perform a method for producing a product. A “patent assertion entity” is preferably also understood to be an entity that is engaged in at least one inter partes activity, e.g., the licensing or the litigation of a patent owned by the patent assertion entity. Further details of a patent assertion entity can be found at https://npe.law.stanford.edu/.

Examples of inter partes activities of an IP right include the following: the IP right is opposed in opposition proceedings, the IP right is the subject of a litigation proceedings (e.g., nullity proceedings, patent infringement proceedings), the IP right is licensed to a third party, or a combination of at least two thereof.

The methods, techniques, and applications of “machine learning” and “artificial intelligence”, in particular methods, techniques, and applications for natural language processing, are well-known in the art. These are discussed in, e.g., Singh, S., and Mahmood, A., (2021), “The NLP Cookbook: Modern Recipes for Transformer based Deep Learning Architectures”, arXiv: 2104.10640; Vaswani, A., et al., (2017), “Attention Is All You Need”, arXiv: 1706.03762; Tunstall, L., Von Werra, L., and Wolf, T., (2022), “Natural Language Processing with Transformers”, O'Reilly Media, Inc (ISBN: 9781098103248); the documentation available at the website: https://huggingface.co/.

The invention is now illustrated by non-limiting examples and exemplifying embodiments.

### FIGURES

### List of Figures

The figures serve to exemplify the present invention, and should not be viewed as limiting the invention. Furthermore, the figures are not drawn to scale.

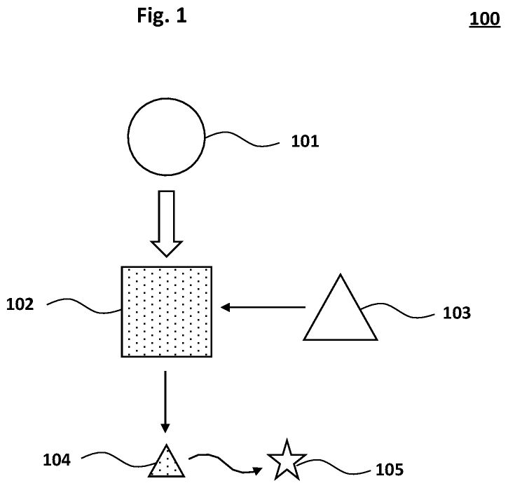

FIG. 1: diagram illustrating a first embodiment of the computer implemented method, according to the invention, for producing an indicator.

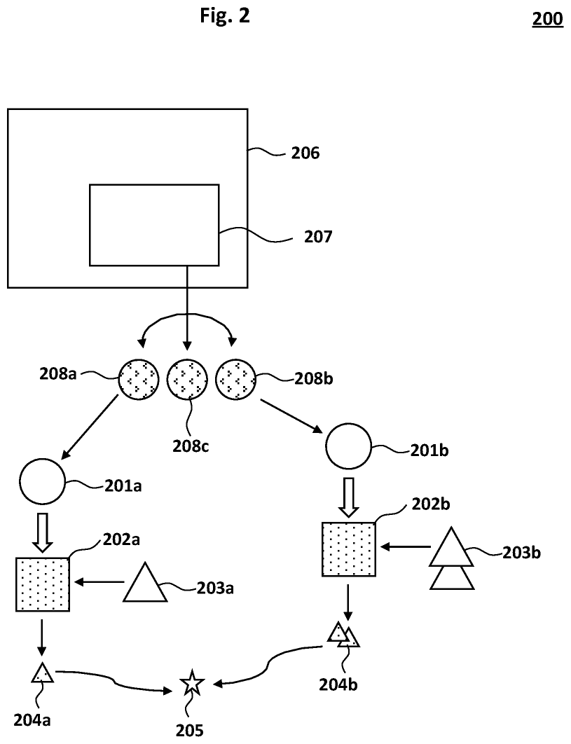

FIG. 2: diagram illustrating a second embodiment of the computer implemented method, according to the invention, for producing an indicator.

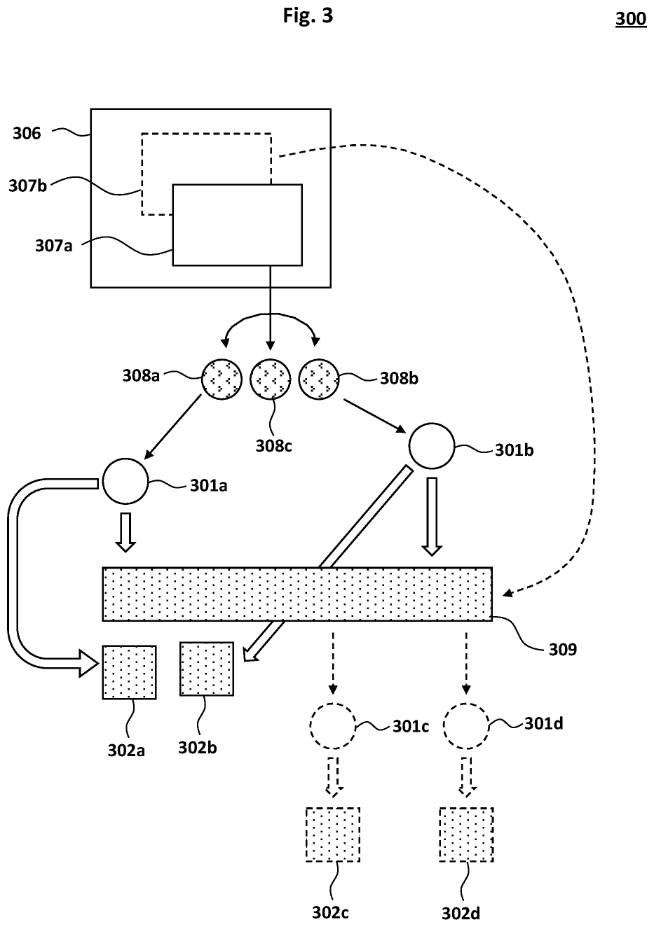

FIG. 3: diagram illustrating a third embodiment of the computer implemented method, according to the invention, for producing an indicator.

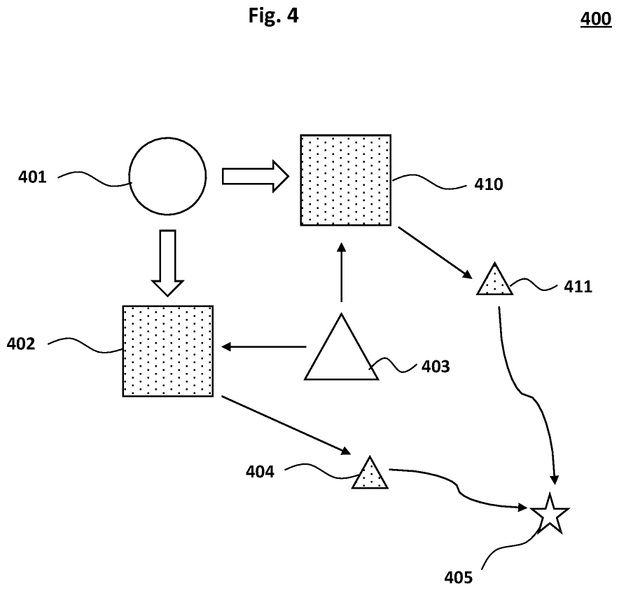

FIG. 4: diagram illustrating a fourth embodiment of the computer implemented method, according to the invention, for producing an indicator.

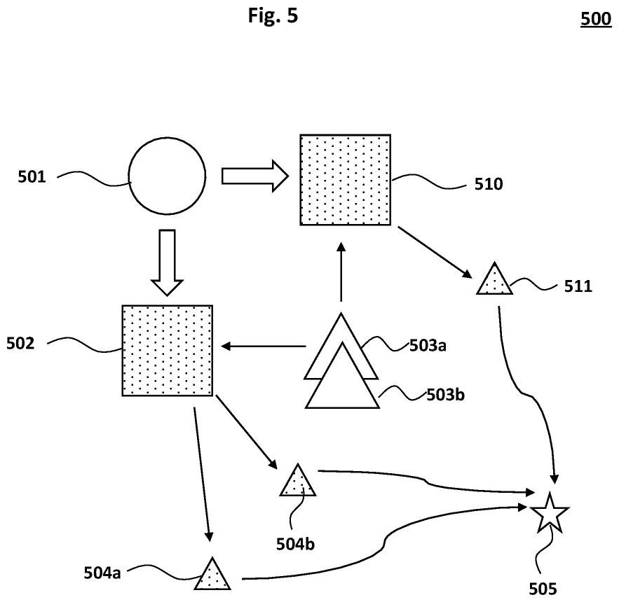

FIG. 5: diagram illustrating a fifth embodiment of the computer implemented method, according to the invention, for producing an indicator.

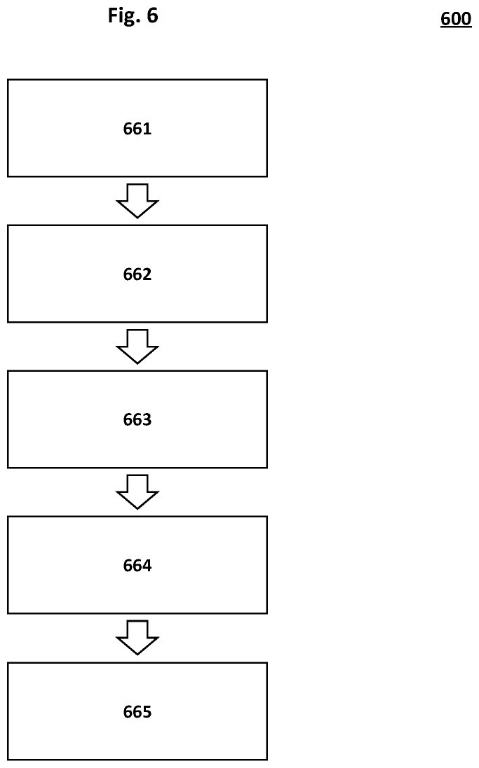

FIG. 6: schematic diagram showing the steps of a first embodiment of the computer implemented method, according to the invention, for producing an indicator.

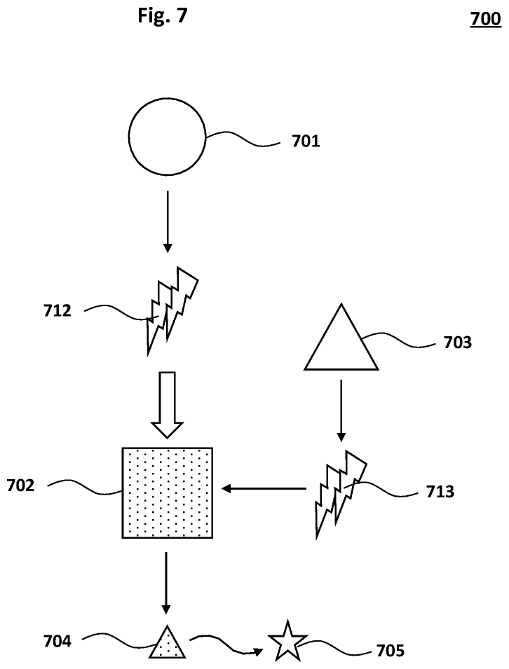

FIG. 7: diagram illustrating a sixth embodiment of the computer implemented method, according to the invention, for producing an indicator.

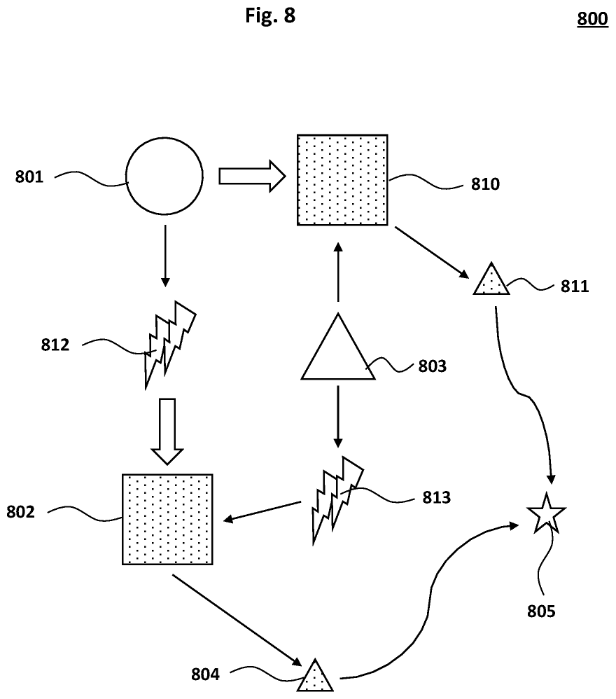

FIG. 8: diagram illustrating a seventh embodiment of the computer implemented method, according to the invention, for producing an indicator.

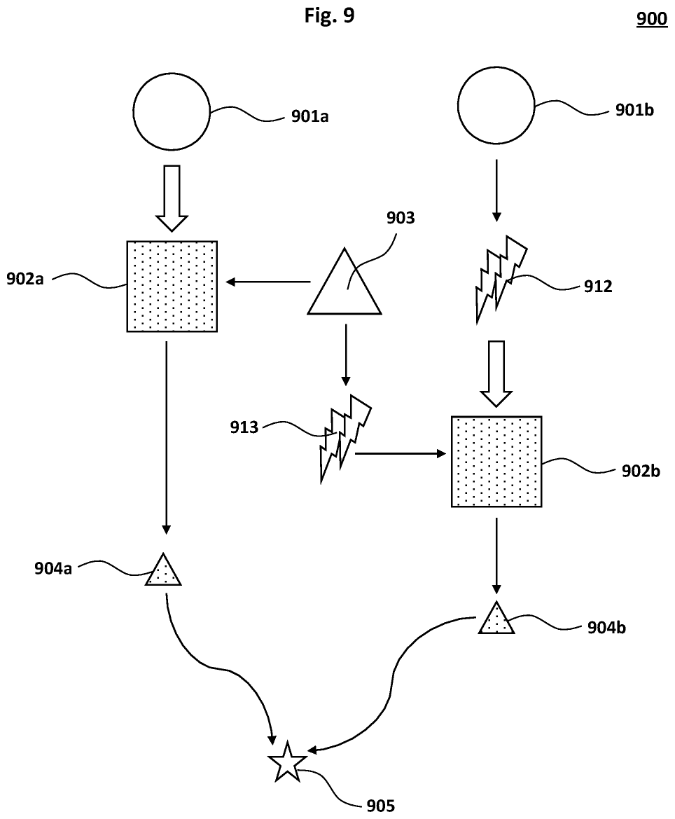

FIG. 9: diagram illustrating an eight embodiment of the computer implemented method, according to the invention, for producing an indicator.

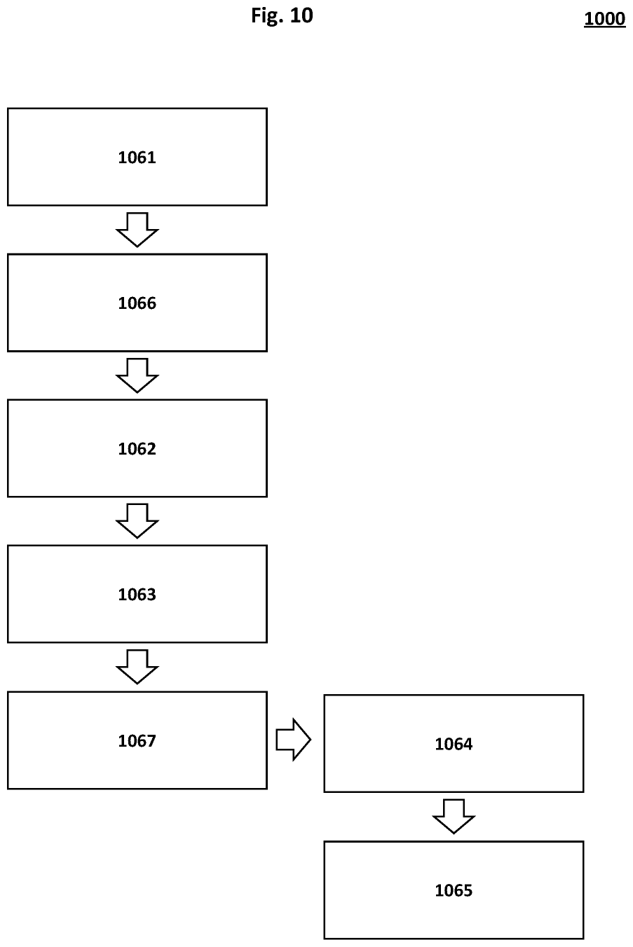

FIG. 10: schematic diagram showing the steps of a second embodiment of the computer implemented method, according to the invention, for producing an indicator.

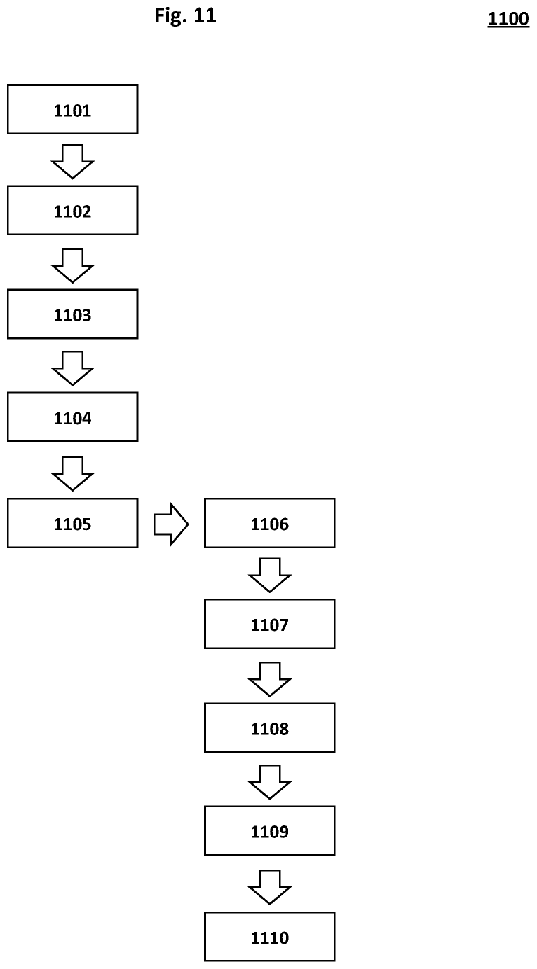

FIG. 11: schematic diagram showing the steps of a third embodiment of the computer implemented method, according to the invention, for producing an indicator.

### DESCRIPTION OF FIGURES

FIG. 1 is a diagram illustrating a first embodiment 100 of the computer implemented method, according to the invention, for producing an indicator. A plurality of IP disclosures of the first kind 101, that all have the same classification, are provided. For example, the inventions disclosed in the plurality of IP disclosures of the first kind 101 all pertain to the field of “robotics”. All IP disclosures of the first kind 101 also comprises text data, such as a description, claims, and an abstract.

FIG. 1 further shows that the plurality of IP disclosures of the first kind 101 is used to obtain a quality index model of the first kind 102. More specifically, the text data of the plurality of IP disclosures of the first kind 101 is used as training data for a machine learning algorithm in order to obtain a quality index model of the first kind 102. I.e., the machine learning algorithm is used to train the quality index model of the first kind 102. The preferred machine learning algorithm is a Bidirectional Encoder Representations from Transformers (BERT) algorithm.

FIG. 1 also shows that an IP product 103 is provided. The IP product 103 also comprises text data. Examples of the IP product 103 include a draft of a claim (i.e., a claim that is not part of a patent application that has been filed), or a claim that forms part of a patent application that has been filed. Furthermore, the IP product 103 has the same classification as the plurality of IP disclosures of the first kind 101. The quality index model of the first kind 102 is used to label the IP product 103 with a quality index of the first kind 104, i.e., the text data of the IP product 103 is used as input in the quality index model of the first kind 102, with the quality index of the first kind 104 being the output of the quality index model of the first kind 102. When labelling the IP product 103 with the quality index of the first kind 104, it is not necessary to provide one or more further IP products. In other words, the quality index of the first kind 104 of the IP product 103 is not determined relative to one or more other IP products, e.g., the quality index of the first kind 104 is not determined by comparing the IP product 103 with the one or more other IP products.

FIG. 1 further shows that the quality index of the first kind 104 is used to obtain an indicator 105. For example, the quality index of the first kind 104 is used as input in a mathematical model, wherein the indicator 105 is obtained as a solution of the mathematical model, or the quality index of the first kind 104 is the indicator 105. In some scenarios, the quality index of the first kind 104 is the indicator 105 that is to be obtained, i.e., the quality index of the first kind 104 is used as the indicator 105. For example, it is desired to predict a likelihood of grant of the IP product 103. This likelihood of grant can be obtained directly from the output of the quality index model of the first kind 102, i.e., the quality index of the first kind 104 is the likelihood of grant. In this case, it is not necessary to use the quality index of the first kind 104 as input in, e.g., a mathematical model, as the quality index of the first kind 104 is used as the indicator 105.

FIG. 2 is a diagram illustrating a second embodiment 200 of the computer implemented method, according to the invention, for producing an indicator. All possible IP disclosures that are available to one or more members of the public are represented by 206. These IP disclosures 206 include patent applications, patents and utility models that have been published. FIG. 2 also shows that a plurality of IP disclosures of the further kind 207, forming part of all possible IP disclosures 206, is provided. The plurality of IP disclosures of the further kind 207 is a sub-set of all possible IP disclosures 206. The plurality of IP disclosures of the further kind 207 can thus be provided by selecting a sub-set of IP disclosures from all possible IP disclosures 206. The selecting can be done randomly, or in a prescribed manner. The plurality of IP disclosures of the further kind 207 can be provided, e.g., by querying a database, such as Espacenet. The plurality of IP disclosures of the further kind 207 also comprises text data.

FIG. 2 also shows that a plurality of classifications 208a, 208b, 208c is provided. The plurality of IP disclosures of the further kind 207 is classified according to the classifications 208a, 208b, 208c, leading to the obtaining of pluralities of IP disclosures of the first kind 201a and 201b. All IP disclosures, that are comprised in a plurality of IP disclosures of the first kind, have the same classification. E.g., all IP disclosure in the plurality of IP disclosures of the first kind 201a have the same classification. It should, however, be noted that an IP disclosure can be part of multiple pluralities of IP disclosures of the first kind. E.g., the following two classifications are provided: “renewable energy” and “batteries”. After classification of a plurality of IP disclosures of the further kind, there are a first plurality of IP disclosures of the first kind that corresponds to the classification “renewably energy”, and a further plurality of IP disclosures of the first kind that corresponds to the classification “batteries”. An IP disclosure that pertains to a Lithium-ion battery may be classified as both “renewable energy” and a “battery”. In this case, the IP disclosure will be part of both pluralities of IP disclosures of the first kind. Although FIG. 2 shows a plurality of classifications 208a, 208b, 208c, it is possible to provide a single classification. In this case, an IP disclosure of the further kind 207 will be classified as belonging to the single classification, or not belonging to the single classification.

FIG. 2 also shows that each plurality of IP disclosures of the first kind (201a and 201b) is used to obtain a quality index model of the first kind, i.e., 202a and 202b. In other words, a separate quality index model of the first kind is obtained for each of the classifications 208a, 208b, 208c (for simplicity, the quality index model of the first kind corresponding to 208c is not shown). The quality index models of the first kind 202a and 202b are obtained as described in FIG. 1. FIG. 2 further shows that IP products 203a (a single IP product) and 203b (comprising multiple IP products), that comprise text data, are provided. These IP products 203a and 203b are classified according to the classifications 208a, 208b, 208c. This is done either by hand, or using a classification model. The classification assigned to an IP product determines which quality index model of the first kind is used to label the IP product with a quality index of the first kind. E.g., the quality index model of the first kind 202b is used to label the IP products 203b, with both the quality index model of the first kind 202b and the IP products 203b having the same classification. The IP products 203a and 203b are labelled as described in FIG. 1. As shown in FIG. 2, each IP product is labelled with its own quality index of the first kind. E.g., each IP product in 203b is labelled with a separate quality index of the first kind 204b.

FIG. 2 further shows that all of the quality indices of the first kind 204a and 204b are used to obtain an indicator 205. It is, however, also possible to obtain multiple indicators. For example, an indicator is obtained for the IP product 203a, and separate indicators are obtained for each of the IP products 203b. As another example, a single indicator is obtained for all IP products 203b. Furthermore, to obtain an indicator, e.g., one or more quality indices of the first kind 204 are used as input in a mathematical model, wherein the indicator is obtained as a solution of the mathematical model, or each quality index of the first kind 204 is an indicator.

FIG. 3 is a diagram illustrating a third embodiment 300 of the computer implemented method, according to the invention, for producing an indicator. Similar to FIG. 2, FIG. 3 shows that a plurality of IP disclosures of the further kind 307a, forming part of all possible IP disclosures 306, is provided. The plurality of IP disclosures of the further kind 307a comprise text data. Also provided is a plurality of classifications 308a, 308b, 308c. Also similar to FIG. 2, FIG. 3 shows that the plurality of IP disclosures of the further kind 307a is classified according to the classifications 308a, 308b, 308c, leading to the obtaining of the pluralities of IP disclosures of the first kind 301a and 301b. All IP disclosures, that are comprised in a plurality of IP disclosures of the first kind, have the same classification. As discussed in FIGS. 1 and 2, each plurality of IP disclosures of the first kind is used to obtain a quality index model of the first kind, i.e., 302a and 302b.

In addition, FIG. 3 shows that the pluralities of IP disclosures of the first kind 301a and 302b are used to obtain a classification model 309. More specifically, the text data of the pluralities of IP disclosures of the first kind 301a and 302b are used as training data for a machine learning algorithm in order to obtain the classification model 309. I.e., the machine learning algorithm is used to train the classification model 309. The preferred machine learning algorithm is a Bidirectional Encoder Representations from Transformers (BERT) algorithm.

Once the quality index models of the first kind 302a and 302b are obtained, the quality indices of the first kind and indicator(s) are obtained as described for FIGS. 1 and 2.

In an alternative embodiment of FIG. 3 (indicated by the features with dashed lines), the pluralities of IP disclosure of the first kind 301a and 301b are not used to obtain the quality index models of the first kind 302a and 302b. Rather, once the classification model 309 has been obtained, a plurality of IP disclosures of the further kind 307b is provided. Using the classification model 309, the plurality of IP disclosures of the further kind 307b is classified, according to the classifications 308a, 308b, and 308c, to obtain the pluralities of IP disclosures of the first kind 301c and 301d, which, in turn, are used to obtain the quality index models of the first kind 302c and 302d, respectively. In this alternative embodiment, the plurality of IP disclosures of the further kind 307a and the plurality of IP disclosures of the further kind 307b may at least partially or completely overlap, i.e., comprise the same IP disclosures. Once the quality index models of the first kind 302c and 302d are obtained, the quality indices of the first kind and indicator(s) are obtained as described for FIGS. 1 and 2.

FIG. 4 is a diagram illustrating a fourth embodiment 400 of the computer implemented method, according to the invention, for producing an indicator. This fourth embodiment is an extension of the embodiment described in FIG. 1. FIG. 4. shows that the plurality of IP disclosures of the first kind 401 is used to obtain a quality index model of the further kind 410. The quality index model of the further kind 410 can be obtained by e.g., using the IP disclosures of the first kind 401 as input in a machine learning algorithm in order train the quality index model of the further kind 410, or using the IP disclosures of the first kind 401 to derive a mathematical equation.

FIG. 4 also shows that the quality index model of the further kind 410 is used to label the IP product 403 with a quality index of the further kind 411, i.e., the IP product 403 is used as input in the quality index model of the further kind 410, with the quality index of the further kind 411 being the output of the quality index model of the further kind 410. FIG. 4 further shows that the quality index of the first kind 404 and the quality index of the further kind 411 is used to obtain the indicator 405.

FIG. 5 is a diagram illustrating a fifth embodiment 500 of the computer implemented method, according to the invention, for producing an indicator. The fifth embodiment is similar to the embodiment shown in FIG. 4., except that a plurality of IP products 503a and 503b are provided. Each of these IP products 503a and 503b are respectively labelled with quality indices of the first kind 504a and 504b using the quality index model of the first kind 502. Furthermore, in contrast to FIG. 4, FIG. 5 shows that a single, quality index of the further kind 511 is calculated for all of the IP products 503a and 503b, using the quality index model of the further kind 510. The single, quality index of the further kind 511, along with the quality indices of the first kind 504a and 504b, are used to obtain the indicator 505. In FIG. 5, it is preferred that the IP products 503a and 503b are owned by the same entity.

FIG. 6 is a schematic diagram showing the steps of a first embodiment 600 of the computer implemented method, according to the invention, for producing an indicator. In step 661 a plurality of IP disclosures of the first kind is provided, wherein at least one of the IP disclosures comprises text data. In Step 662, at least one quality index model of the first kind is obtained using the plurality of IP disclosures of the first kind. In particular, the at least one quality index model of the first kind is obtained using the text data of at least one IP disclosure that is comprised in the plurality of IP disclosures of the first kind. In step 663, at least one IP product, that comprises text data, is provided. In step 664, the at least one IP product is labelled with at least one quality index of the first kind, using the at least one quality index model of the first kind. More particularly, the at least one IP product is labelled with the quality index of the first kind independently of at least one other IP product. In step 665, the indicator is obtained using the at least one quality index of the first kind.

FIG. 7 is a diagram illustrating a sixth embodiment 700 of the computer implemented method, according to the invention, for producing an indicator. A plurality of IP disclosures of the first kind 701, that all comprise text data (such as a description, claims, and an abstract), are provided. In contrast to FIG. 7, the IP disclosures of the first kind 701 do not necessarily all have the same classification.

FIG. 7 further shows that the text data of the plurality of IP disclosures of the first kind 701 are vectorized to obtain first text vectors 712. The first text vectors 712 are used to obtain a quality index model of the first kind 702. More specifically, the first text vectors 712 are used as training data for a neural network algorithm in order to obtain the quality index model of the first kind 702. I.e., the neural network algorithm is used to train the quality index model of the first kind 702. The preferred neural network algorithm is a feedforward neural network. Together with the first text vectors 712, the quality index model of the first kind 702 may also be obtained using numerical data (e.g., the number of citations) of the plurality of IP disclosures of the first kind 701.

FIG. 7 also shows that an IP product 703 is provided. The IP product 703 also comprises text data. Examples of the IP product 703 include a draft of a claim (i.e., a claim that is not part of a patent application that has been filed), or a claim that forms part of a patent application that has been filed. Furthermore, the IP product 703 may, or may not, have the same classification as at least one of the plurality of IP disclosures of the first kind 701. The text data of the IP product 703 is vectorized to obtain further text vectors 713. The quality index model of the first kind 702 is used to label the IP product 703 with a quality index of the first kind 704, i.e., the further text vectors 713 are used as input in the quality index model of the first kind 702, with the quality index of the first kind 704 being the output of the quality index model of the first kind 702. When labelling the IP product 703 with the quality index of the first kind 704, it is not necessary to provide one or more further IP products. In other words, the quality index of the first kind 704 of the IP product 703 is not determined relative to one or more other IP products, e.g., the quality index of the first kind 704 is not determined by comparing the IP product 703 with the one or more other IP products.

FIG. 7 further shows that the quality index of the first kind 704 is used to obtain an indicator 705. For example, the quality index of the first kind 704 is used as input in a mathematical model, wherein the indicator 705 is obtained as a solution of the mathematical model, or the quality index of the first kind 704 is the indicator 705.

If a plurality of IP products 703 is provided in FIG. 7, the text date of each IP product 703 is vectorized to obtain further text vectors 713 associated with a specific IP product 703. Using the further text vectors 713 associated with a specific IP product 703 as input for the quality index model of the first kind 702, each IP product 703 is labelled with its own quality index of the first kind 704. The quality indices of the first kind 704 can collectively be used to obtain a single indicator 705, or each quality index of the first kind 704 can be used to obtain an individual indicator for each IP product 703.

FIG. 8 is a diagram illustrating a seventh embodiment 800 of the computer implemented method, according to the invention, for producing an indicator. This seventh embodiment is an extension of the embodiment described in FIG. 7. FIG. 8. shows that the plurality of IP disclosures of the first kind 801 is used to obtain a quality index model of the further kind 810. The quality index model of the further kind 810 can be obtained by e.g., using the IP disclosures of the first kind 801 as input in a machine learning algorithm in order train the quality index model of the further kind 810, or using the IP disclosures of the first kind 801 to derive a mathematical equation.

FIG. 8 also shows that the quality index model of the further kind 810 is used to label the IP product 803 with a quality index of the further kind 811, i.e., the IP product 803 is used as input in the quality index model of the further kind 810, with the quality index of the further kind 811 being the output of the quality index model of the further kind 810. FIG. 8 further shows that the quality index of the first kind 804 and the quality index of the further kind 811 is used to obtain the indicator 805.

If a plurality of IP products 803 is provided in FIG. 8, the method is performed as described in FIG. 5, with the following exceptions: the quality index model of the first kind 801 is obtained as described in FIG. 7 (i.e., using first text vectors 812), and the quality indices of the first kind 804 are obtained using further text vectors 813 (calculated for each) as input for the quality index model of the first kind 802.

FIG. 9 is a diagram illustrating an eight embodiment 900 of the computer implemented method, according to the invention, for producing an indicator. In FIG. 9, a first plurality of IP disclosures of the first kind 901a is provided and used to obtain a first quality index model of the first kind 902a, as described in FIG. 1 (i.e., the first plurality of IP disclosures of the first kind 901a all have the same classification). The first quality index model of the first kind 902a is then used to label an IP product 903 with a first quality index of the first kind 904a, as described in FIG. 1. An example of the first quality index of the first kind 904a is a likelihood of grant of the IP product 903. If the likelihood of grant is to be determined, it is preferred to use a BERT algorithm to obtain the first quality index model of the first kind 902a.

FIG. 9 also shows that a further plurality of IP disclosures of the first kind 901b is provided and used to obtain a further quality index model of the first kind 902b, as described in FIG. 7 (i.e., the further plurality of IP disclosures of the first kind 901b do not necessarily all have the same classification, the further quality index model of the first kind 902b is obtained by first text vectors 912). The further quality index model of the first kind 902b is then used to label the IP product 903 with a further quality index of the first kind 904b, as described in FIG. 7 (i.e., using further text vectors 913). An example of the further quality index of the first kind 904b is a likelihood of the IP product 903 obtaining a number of citations after publication of the IP product 903. If the likelihood of a number of citations is to be determined, it is preferred to use a deep neural network to obtain the further quality index model of the first kind 902b.

FIG. 9 further shows that both the first quality index of the first kind 904a and the further quality index of the first kind 904b are used to obtain the indicator 905 for the IP product 903. If a plurality of IP products are provided, a first quality index of the first kind and a further quality index of the first kind are obtained for each IP product. An indicator can than either be obtained for each IP product using the first quality index of the first kind and the further quality index of the first kind obtained for a specific IP product, or a single indicator can be obtained using all the first quality indices of the first kind and the further quality indices of the first kind. Alternatively, one or more quality indices of the further kind (obtained as described in e.g., FIGS. 4 and 8), may also be used, along with the first quality index of the first kind and the further quality index of the first kind, to obtain one or more indicators.

FIG. 10 is a schematic diagram showing the steps of a second embodiment 1000 of the computer implemented method, according to the invention, for producing an indicator. In Step 1061 a plurality of IP disclosures of the first kind is provided, wherein at least one of the IP disclosures comprises text data. In Step 1066, the text data of the at least one of the IP disclosure of the first kind that comprises text data is vectorized to obtain first text vectors. In Step 1062, at least one quality index model of the first kind is obtained using the plurality of IP disclosures of the first kind. In particular, the at least one quality index model of the first kind is obtained using the first text vectors. Furthermore, the at least one quality index model of the first kind is obtained using a neural network, such as a feedforward neural network. In Step 1063, at least one IP product, that comprises text data, is provided. In Step 1067, the text data of the at least one IP product is vectorized to obtain further text vectors. In Step 1064, the at least one IP product is labelled with at least one quality index of the first kind, using the at least one quality index model of the first kind. More particularly, the at least one IP product is labelled with the quality index of the first kind independently of at least one other IP product. Furthermore, the further text vectors are used as input in the at least one quality index model of the first kind in order to obtain the quality index of the first kind. In Step 1065, the indicator is obtained using the at least one quality index of the first kind.

FIG. 11 is a schematic diagram showing the steps of a third embodiment 1100 of the computer implemented method, according to the invention, for producing an indicator. In Step 1101, a classification is provided, e.g., light emitting diodes (LEDs). In Step 1102, the companies (at least one entity) that are active in the field of the classification is identified. A company is defined as being active in the field of the classification if the company, e.g., produces a product that would fall under the classification, or owns at least one IP right that would fall under the classification. For example, the company produces LEDs, and owns a patent pertaining to a method for the production of blue LEDs. In Step 1103, the IP rights of the companies identified in step 1102 are identified (further plurality of IP disclosures of the first kind). These IP rights may or may not fall under the classification. In Step 1104, the IP rights subjected to inter partes activities in the field of the classification is identified (first plurality of IP disclosures of the first kind). The inter partes activities include patent litigation cases that are related to LEDs, or the number of licenses, pertaining to LED technologies, that have been granted to third party companies. In Step 1105, the overlap of the first plurality of IP disclosures of the first kind and the further plurality of IP disclosures of the first kind is determined, i.e., the number of IP rights which form part of both the first plurality of IP disclosures of the first kind and the further plurality of IP disclosures of the first kind is determined. In Step 1106, the number of companies, identified in Step 1102, that are patent assertion entities (e.g., so-called patent trolls) are identified. In Step 1107 an even-further plurality of IP disclosures of the first kind is provided, wherein at least one of these IP disclosures comprises text data, and wherein these IP disclosures of the first kind also fall under the classification provided in Step 1101. In Step 1108, at least one quality index model of the first kind is obtained using the even-further plurality of IP disclosures of the first kind, the number of inter partes activities in the field of the classification, and the number (Step 1104), and the number of IP rights which form part of both the first plurality of IP disclosures of the first kind and the further plurality of IP disclosures of the first kind (Step 1105). Furthermore, the at least one quality index model of the first kind is obtained using the text data of at least one IP disclosure that is comprised in the even-further plurality of IP disclosures of the first kind. In Step 1108, at least one IP product, that comprises text data, is provided. In step 1109, the at least one IP product is labelled with at least one quality index of the first kind, using the at least one quality index model of the first kind. More particularly, the at least one IP product is labelled with the quality index of the first kind independently of at least one other IP product. The quality index of the first kind is, e.g., the likelihood that the IP product will be involved in litigation proceedings. In step 1110, the indicator is obtained using the at least one quality index of the first kind.

### EXAMPLES

The invention is illustrated further by way of examples. The invention is not restricted to the examples.

### Basic Set-Up

The following applies to both comparative example 1 and inventive examples 1 and 2: an employee of a company drafts a claim set comprising 30 claims (at least one IP product). The claims will form part of patent application that will be filed in multiple regions and countries, e.g., Korea, China, the USA, and Europe. The employee needs to determine whether the draft of the claims meets the requirements (e.g., clarity, no multi-dependent claims, the number of allowable independent claims per category) of the respective patent office.

### Comparative Example 1

In order to determine if the claims meet the above-mentioned requirements, the employee first obtains 100 patents that were granted by the respective patent offices. This requires that a computer of the employee must have access to the Internet and databases such as Espacenet. Due to being connected to the Internet, the employee's computer is at risk of being accessed by 3^{rd} parties that are hostile to the employee and/or her employer. For example, a 3^{rd} party that wants to steal the intellectual property of the employer.

In order to obtain the patents, a search query of the database has to be performed. The patents that are obtained thereby are then stored locally on the hard disk of the employee's computer.

After having obtained the patents, the employee evaluates and compares the claims of the 100 granted patents with the draft of the claims. In order to compare the claims, the employee uses a 29″ computer screen in order to place claims of a granted patent next to the draft of the claims on the screen. The evaluation is performed using, amongst others, software that compares the granted claims with the draft of the claims.

### Inventive Example 1

A quality index model of the first kind, according to the invention, is obtained from a 3^{rd} party. The quality index model of the first kind is loaded onto a laptop that has a 12″ computer screen. The laptop is not connected to a computer network, e.g., the Internet. The employee uses the quality index model of the first kind to evaluate the draft of the claims, e.g., by copying the claims into a graphical user interface of software that uses the quality index model of the first kind.

Each of the 30 claims that were drafted are labelled with multiple quality indices of the first kind. Each quality index provides the likelihood that a claim will be objected to due to not meeting a specific requirement, e.g., clarity, in proceedings before a specific patent office. For example, a first quality index of the first kind is the likelihood of a clarity objection before the United States Patent and Trademark Office, a second quality index of the first kind is the likelihood of a clarity objection before the European Patent Office, a third quality index of the first kind is the likelihood of a clarity objection before the European Patent Office due to more than one independent claim per claim category. Therefore, first quality indices are obtained that correspond to each patent office of interest.

In order to obtain the quality indices of the first kind, the quality index model of the first kind does not require that the employee provide patent or patent applications that were, e.g., obtained from a database.

An indicator is obtained for each patent office by averaging the quality indices of a first kind that correspond to a specific patent office.

Table 1 shows the advantages of inventive example 1, compared to comparative example 1. A “+” indicates an improvement in the desired effect. The number of “+” indicates the level of improvement. A “−” indicates a decrease in the desired effect. The number of “−” indicates the level of decrease. In particular, it is desired to have increased network security, it is desired to use less hard disk space, it is desired that the time to evaluate the draft of the claims is reduced, and it is desired that the visualisation resources that are required are reduced.

TABLE 1
a comparison of inventive example 1 and comparative example 1

| Effect | Inventive example 1 | Comparative example 1 |
|---|---|---|
| Requires network connection | No | Yes |
| Database search required | No | Yes |
| Network security | +++ | −− |
| Use of hard disk space | ++ | + |
| Time to evaluate draft of | +++ | −−− |
| claims | | |
| Visualisation resources | +++ | ++ |
| required | | |

### Inventive Example 2

Inventive example 2 is similar to inventive example 1, except for the following difference: the quality index model of the first kind is loaded onto a smart phone. Although the smart phone may be connected to a computer network, e.g., the Internet, this is not required. The employee uses the quality index model of the first kind to evaluate the draft of the claims, e.g., by using a smart phone app to scan the claims. The app comprises software that uses the quality index model of the first kind. The difference between inventive example 2 and inventive example 1 is thus the use of a smart phone vs the use of a laptop. The technical advantages that inventive example 1 has over comparative example 1, as shown in Table 1, also applies to inventive example 2.

### Inventive Example 3

A first quality index model of the first kind is obtained as follows: a number of classifications, such as “recycling of polyethylene terephthalate” and “robotics”, are provided. The classifications are thus based on concepts that are readily understandable by a skilled person, as opposed to the classifications being based on, e.g., the abstract features (such as “method for reconstituting a polymer”) that appear in the claims of patents and patent applications.

100 000 IP disclosures of the further kind (published patents, patent applications, and utility models) are retrieved randomly (provided) from the Espacenet database. The IP disclosures of the further kind are classified (providing a plurality of IP disclosures of the first kind) by a classification model according to the classifications. This classification of the IP disclosures of the further kind leads to the obtaining of IP disclosure of the first kind (classified patents, patent applications, and utility models). After the classification process has been completed, each classification contains between 100 and 1000 IP disclosures of the first kind. Any IP disclosure of the further kind that cannot be classified according to the classifications is discarded.

Each of the IP disclosures of the first kind that have been classified are labelled with numerical data. The numerical data is based on whether an IP disclosure of the first kind is pending, has been granted or rejected, the number of forward citations, and a Market Coverage.

Using a machine learning algorithm, a quality index model of the first kind is trained (obtained) for each classification. The training of a quality index model of the first kind for a specific classification is performed using the IP disclosure of the first kind that correspond to the specific classification. The quality index models of the first kind are trained using a Bidirectional Encoder Representations from Transformers (BERT) algorithm. More particularly, the descriptions and claims of the IP disclosures of the first kind are used input in the BERT algorithm, along with the numerical data mentioned in the previous paragraph.

Further details of training BERT using the description and claims of patents and patent applications can be found in, e.g., Freunek, M., and Bodmer A., (2021), “BERT based patent novelty search by training claims to their own description”, arXiv: 2103.01126; and Freunek, M., and Bodmer A., (2021), “BERT based freedom to operate patent analysis”, arXiv: 2105.00817. Further details using machine learning algorithms, such as BERT, are well-known to the skilled person.

90% of the IP disclosure of the first kind, for a given classification, are used to train the quality index model of the first kind for that classification. The remaining 10% of the IP disclosure of the first kind are used to validate quality index model of the first kind.

### Basic Set-Up

The following applies to comparative example 2 and inventive examples 4 and 5: an employee of a company drafts an independent claim (at least one IP product). The independent claim will form part of a patent application that will be filed in multiple regions and countries, e.g., Korea, China, the USA, and Europe. The employee needs to determine the likelihood that the claims will be granted in the different regions and countries.

### Comparative Example 2

In order to determine the likelihood that the independent claim will be granted, comparative example 2 is performed in the same manner as described in comparative example 1, with the following difference: the employee compared the draft of the independent claim with the independent claims of the patents that were obtained by querying a database.

### Inventive Example 4

A quality index model of the first kind, according to the invention, is obtained. The quality index model of the first kind is for use for IP products that have a specific classification. The quality index model of the first kind is loaded onto a laptop that has a 12″ computer screen. The laptop is not connected to a computer network, e.g., the Internet. The employee uses the quality index model of the first kind to evaluate the draft of the independent claim, e.g., by copying the independent claim into a graphical user interface of software that uses the quality index model of the first kind.

The drafted independent claims is labelled with multiple quality indices of the first kind. Each quality index of the first kind provides the likelihood that the independent claim will be granted in proceedings before a specific patent office. For example, a first quality index of the first kind is the likelihood of grant before the United States Patent and Trademark Office, a second quality index of the first kind is the likelihood of grant before the European Patent Office. Therefore, a separate quality index of the first kind is obtained for each patent office of interest.

In order to obtain the quality indices of the first kind, the quality index model of the first kind does not require that the employee provide patent or patent applications that were, e.g., obtained from a database.

An indicator is obtained by averaging over the quality indices of the first kind.

Table 2 shows the advantages of inventive example 4, compared to comparative example 2. A “+” indicates an improvement in the desired effect. The number of “+” indicates the level of improvement. A “−” indicates a decrease in the desired effect. The number of “−” indicates the level of decrease. In particular, it is desired to have increased network security, it is desired to use less hard disk space, it is desired that the time to evaluate the draft of the independent claim is reduced, and it is desired that the visualisation resources that are required are reduced.

TABLE 2
a comparison of inventive example 4 and comparative example 2

| Effect | Inventive example 4 | Comparative example 2 |
|---|---|---|
| Requires network connection | No | Yes |
| Database search required | No | Yes |
| Network security | +++ | −− |
| Use of hard disk space | ++ | + |
| Time to evaluate draft of | +++ | −−− |
| independent claim | | |
| Visualisation resources | +++ | ++ |
| required | | |

### Inventive Example 5

Inventive example 5 is similar to inventive example 4, except for the following difference: the quality index model of the first kind is loaded onto a smart phone. Although the smart phone may be connected to a computer network, e.g., the Internet, this is not required. The employee uses the quality index model of the first kind to evaluate the draft of the independent claim, e.g., by using a smart phone app to scan the independent claim. The app comprises software that uses the quality index model of the first kind. The difference between inventive example 5 and inventive example 4 is thus the use of a smart phone vs the use of a laptop. The technical advantages that inventive example 4 has over comparative example 2, as shown in Table 2, also applies to inventive example 5.

### Inventive Example 6

A quality index model of the first kind, used for predicting the probability of grant for one or more claims, is obtained as described in inventive example 3, with the following difference. In inventive example 3, each of the IP disclosures of the first kind that have been classified are labelled with numerical data that is based on whether an IP disclosure of the first kind is pending, has been granted or rejected, the number of forward citations, and a Market Coverage. In inventive example 6, each of the IP disclosures of the first kind that have been classified are labelled with numerical data, where the numerical data is based on whether an IP disclosure was granted, rejected, withdrawn, or deemed withdrawn.

### Basic Set-Up

The following applies to comparative example 3 and inventive examples 7 and 8: an employee of a company drafts a patent application that has a claim set comprising 30 claims (at least one IP product). The patent application will be filed in multiple regions and countries, e.g., Korea, China, the USA, and Europe. The employee needs to determine the number of citations that the patent application will likely receive.

### Comparative Example 3

In order to determine the number of citations that the patent application drafted by the employee will likely receive, the employee first obtains 1000 patent and patent applications. This requires that a computer of the employee must have access to the Internet and databases such as Espacenet. Due to being connected to the Internet, the employee's computer is at risk of being accessed by 3^{rd} parties that are hostile to the employee and/or her employer. For example, a 3^{rd} party that wants to steal the intellectual property of the employer.

In order to obtain the patents and patent application, a search query of the database has to be performed. The patents and patent applications that are obtained thereby are then stored locally on the hard disk of the employee's computer. After having obtained the patents and patent applications, the employee evaluates and compares the 1000 patents and patent applications with the patent application drafted by the employee. In order to perform the comparison, the employee uses a 29″ computer screen in order to place the description and claims of a patent or patent application next to the description and claims of the patent application drafted by the employee. The evaluation is performed using, amongst others, software that compares the patent description of the patent or patent application with the description of the drafted patent application.

### Inventive Example 7

A quality index model of the first kind, according to the invention, is obtained. The quality index model of the first kind is not limited to IP products that have a specific classification, i.e., the IP product does not need to be classified according to a classification. The quality index model of the first kind is loaded onto a laptop that has a 12″ computer screen. The laptop is not connected to a computer network, e.g., the Internet. The employee uses the quality index model of the first kind to evaluate the description and claims of the patent application drafted by the employee, e.g., by copying the drafted description and claims into a graphical user interface of software that uses the quality index model of the first kind.

The patent application drafted by the employee is labelled with a quality index of the first kind. The quality index of the first kind provides the number of citations that the drafted patent application will likely receive. In order to obtain the quality index of the first kind, the quality index model of the first kind does not require that the employee provide patent or patent applications that were, e.g., obtained from a database. An indicator is obtained by using the quality index of the first kind directly as the indicator.

Table 3 shows the advantages of inventive example 7, compared to comparative example 3. A “+” indicates an improvement in the desired effect. The number of “+” indicates the level of improvement. A “−” indicates a decrease in the desired effect. The number of “−” indicates the level of decrease. In particular, it is desired to have increased network security, it is desired to use less hard disk space, it is desired that the time to evaluate the draft of the patent application is reduced, and it is desired that the visualisation resources that are required are reduced.

TABLE 3
a comparison of inventive example 7 and comparative example 3

| Effect | Inventive example 7 | Comparative example 3 |
|---|---|---|
| Requires network connection | No | Yes |
| Database search required | No | Yes |
| Network security | +++ | −− |
| Use of hard disk space | ++ | + |
| Time to evaluate patent | +++ | −−− |
| application | | |
| Visualisation resources | +++ | ++ |
| required | | |

### Inventive Example 8

Inventive example 8 is similar to inventive example 7, except for the following difference: the quality index model of the first kind is loaded onto a smart phone. Although the smart phone may be connected to a computer network, e.g., the Internet, this is not required. The employee uses the quality index model of the first kind to evaluate the draft of the patent application, e.g., by using a smart phone app to scan the patent application. The app comprises software that uses the quality index model of the first kind. The difference between inventive example 8 and inventive example 7 is thus the use of a smart phone vs the use of a laptop. The technical advantages that inventive example 7 has over comparative example 3, as shown in Table 3, also applies to inventive example 8.

### Inventive Example 9

A quality index model of the first kind used for, e.g., predicting a number of citations that a patent application will likely receive, is obtained as follows:

100 000 IP disclosures of the first kind (published patents, patent applications, and utility models) are retrieved randomly (provided) from the Espacenet database. The IP disclosures of the first kind are not classified according to a classification. Each of the IP disclosures of the first kind are labelled with numerical data. The numerical data is based on the number of citations that an IP disclosure of the first kind has received.

The description and claims of the IP disclosures of the first kind are vectorized using a transformer model to obtain text vectors, e.g., using the SentenceTransformers framework.

Using the text vectors and the numerical data as input, a feedforward neural network is used to obtain the quality index model of the first kind.

90% of the IP disclosure of the first kind are used to train the quality index model of the first kind. The remaining 10% of the IP disclosure of the first kind are used to validate the quality index model of the first kind.

### REFERENCE LIST

100 First embodiment of a computer-implemented method for producing an indicator
101 Plurality of IP disclosures of the first kind
102 Quality index model of the first kind
103 IP product
104 Quality index of the first kind
105 Indicator
200 Second embodiment of a computer-implemented method for producing an indicator
201 Plurality of IP disclosures of the first kind
202 Quality index model of the first kind
203 IP product
204 Quality index of the first kind
205 Indicator
206 All available IP disclosures
207 Plurality of IP disclosures of the further kind
208 Plurality of classifications
300 Third embodiment of a computer-implemented method for producing an indicator
301 Plurality of IP disclosures of the first kind
302 Quality index model of the first kind
306 All available IP disclosures
307 Plurality of IP disclosures of the further kind
308 Plurality of classifications
309 Classification model
400 Fourth embodiment of a computer-implemented method for producing an indicator
401 Plurality of IP disclosures of the first kind
402 Quality index model of the first kind
403 IP product
404 Quality index of the first kind
405 Indicator
410 Quality index model of the further kind
411 Quality index of the further kind
500 Fifth embodiment of a computer-implemented method for producing an indicator
501 Plurality of IP disclosures of the first kind
502 Quality index model of the first kind
503 IP products
504 First quality index
505 Indicator
510 Quality index model of the further kind
511 Quality index of the further kind
600 Steps of a first embodiment of a computer implemented method, according to the invention, for producing an indicator
661 Providing a plurality of IP disclosures of the first kind, wherein at least one of the IP disclosures comprises text data
662 Obtaining at least one quality index model of the first kind using the plurality of IP disclosures of the first kind
663 Providing at least one IP product that comprises text data
664 Labelling the at least one IP product with at least one quality index of the first kind, using the at least one quality index model of the first kind
665 Obtaining an indicator using the at least one quality index of the first kind
700 Sixth embodiment of a computer-implemented method for producing an indicator
701 Plurality of IP disclosures of the first kind
702 Quality index model of the first kind
703 IP product
704 Quality index of the first kind
705 Indicator
712 First text vectors of the plurality of IP disclosures of the first kind
713 Further text vectors of the IP product
800 Seventh embodiment of a computer-implemented method for producing an indicator
801 Plurality of IP disclosures of the first kind
802 Quality index model of the first kind
803 IP product
804 Quality index of the first kind
805 Indicator
810 Quality index model of the further kind
811 Quality index of the further kind
812 First text vectors of the plurality of IP disclosures of the first kind
813 Further text vectors of the IP product
900 Eight embodiment of a computer-implemented method for producing an indicator
901a First plurality of IP disclosures of the first kind
901b Further plurality of IP disclosures of the first kind
902a First quality index model of the first kind
902b Further quality index model of the first kind
903 IP product
904a First quality index of the first kind
904b Further quality index of the first kind
905 Indicator
1000 Steps of a second embodiment of a computer implemented method, according to the invention, for producing an indicator
1061 Providing a plurality of IP disclosures of the first kind, wherein at least one of the IP disclosures comprises text data
1066 Vectorising the text data of the at least one IP disclosure of the first kind that comprises text data to obtain first text vectors
1062 Obtaining at least one quality index model of the first kind using the plurality of IP disclosures of the first kind, and in particular the text vector obtained in step 1066
1063 Providing at least one IP product that comprises text data
1067 Vectorising the text data of the at least one IP product to obtain further text vectors
1064 Labelling the at least one IP product with at least one quality index of the first kind, using the at least one quality index model of the first kind, and in particular the further text vectors
1065 Obtaining an indicator using the at least one quality index of the first kind
1100 Steps of a third embodiment of a computer implemented method, according to the invention, for producing an indicator
1101 Providing a classification
1102 Identifying companies active in the field of the classification
1103 Identifying IP rights owned by the companies identified
1104 Identifying IP rights, falling in the field of the classification, that are subjected to inter partes activities
1105 Determining the overlap between the IP rights identified in Step 1103 and the IP rights identified in Step 1104
1106 Providing a plurality of IP disclosures of the first kind, wherein at least one of the IP disclosures comprises text data
1107 Obtaining at least one quality index model of the first kind using the plurality of IP disclosures of the first kind
1108 Providing at least one IP product that comprises text data
1109 Labelling the at least one IP product with at least one quality index of the first kind, using the at least one quality index model of the first kind
1110 Obtaining an indicator using the at least one quality index of the first kind

1-16. (canceled)

17. A computer-implemented method for producing an indicator, wherein the method comprises:
a. obtaining at least one quality index model of the first kind;
b. providing at least one IP product;
c. labelling the at least one IP product, using the at least one quality index model of the first kind, with at least one quality index of the first kind; and
d. obtaining the indicator using the at least one quality index of the first kind;
wherein the at least one IP product is labelled with the quality index of the first kind independently of at least one other IP product.

18. The method of claim 17, wherein the at least one IP product comprises text data, and wherein the method further comprises the step of vectorizing the text data of the at least one IP product.

19. The method of claim 17, wherein the at least one IP product comprises text data, and wherein the at least one IP product is labelled with the quality index of the first kind using the text data of the at least one IP product.

20. The method of claim 17, wherein the at least one quality index model of the first kind is obtained using a plurality of IP disclosures of a first kind.

21. The method of claim 17, wherein the method further comprises providing at least one classification.

22. The method of claim 17, wherein the method further comprises obtaining a classification model.

23. The method of claim 17, wherein at least one of the following is based on the at least one classification:
a. the at least one quality index model of the first kind;
b. the indicator;
c. the classification model.

24. The method of claim 20, wherein at least one of the following applies:
a. the plurality of IP disclosures of the first kind is classified according to the at least one classification;
b. the at least one IP product is classified according to the at least one classification.

25. The method of claim 17, wherein at least one of the following applies:
A.] the at least one quality index model of the first kind;
B.] the indicator, and
C.] the classification model;
are obtained using at least one of the following:
a. machine learning;
b. artificial intelligence.

26. The method of claim 17, wherein the method further comprises:
a. obtaining at least one quality index model of the further kind;
b. labelling the at least on IP product, using the at least one quality index model of the further kind, with at least one quality index of the further kind.

27. The method of claim 17, wherein an indicator is obtained.

28. A process for making a business decision, comprising:
a. obtaining at least one quality index model of the first kind;
b. providing at least one IP product;
c. labelling the at least one IP product, using the at least one quality index model of the first kind, with at least one quality index of the first kind;
d. obtaining the indicator using the at least one quality index of the first kind;
wherein the at least one IP product is labelled with the quality index of the first kind independently of at least one other IP product; and
e. displaying the indicator using at least one of the following: at least one screen of a computer, at least one screen of a laptop, at least one screen of a tablet, at least one screen of a smart phone, a projector, or a combination of two or more thereof.

29. A non-transitory computer-readable medium having computer-executable instructions that, when executed by a computer cause the computer to:
a. obtain at least one quality index model of the first kind;
b. provide at least one IP product;
c. label the at least one IP product, using the at least one quality index model of the first kind, with at least one quality index of the first kind; and
d. obtain the indicator using the at least one quality index of the first kind;
wherein the at least one IP product is labelled with the quality index of the first kind independently of at least one other IP product.

30. The non-transitory computer-readable medium of claim 29 comprising at least one of the following:
a. at least one processing unit;
b. at least one display device;
c. at least one input device;
d. at least one primary storage medium;
e. at least one secondary storage medium; and
wherein at least one or all of the following applies to the non-transitory computer-readable medium:
I./ the at least one processing unit has a clock rate that is less than 6 GHz;
II./ the at least one primary storage medium has less than 8 Gb of storage space.

31. The non-transitory computer-readable medium of claim 29, wherein the at least one IP product comprises text data, and wherein the method further comprises the step of vectorizing the text data of the at least one IP product.

32. The non-transitory computer-readable medium of claim 29, wherein the at least one IP product comprises text data, and wherein the at least one IP product is labelled with the quality index of the first kind using the text data of the at least one IP product.

33. The non-transitory computer-readable medium of claim 29, wherein the at least one quality index model of the first kind is obtained using a plurality of IP disclosures of a first kind.

34. The non-transitory computer-readable medium of claim 29, wherein the method further comprises providing at least one classification.

35. The non-transitory computer-readable medium of claim 29, wherein the method further comprises obtaining a classification model.

36. The non-transitory computer-readable medium of claim 29, wherein at least one of the following is based on the at least one classification:
a. the at least one quality index model of the first kind;
b. the indicator;
c. the classification model.
